(19) United States
(12) Patent Application Publication
(10) Pub. No.: US 2006/0041655 A1
(43) Pub. Date: Feb. 23, 2006

(54) Bi-directional remote control for remotely controllable apparatus

(76) Inventors: Marty Holloway, Sacramento, CA (US); David Smith, El Dorado Hills, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/030,667

(22) Filed: Jan. 5, 2005

Related U.S. Application Data
(60) Provisional application No. 60/569,123, filed on May 6, 2004.

(51) Int. Cl. G06F 15/173

(52) U.S. Cl. 709/223

(57) ABSTRACT

Disclosed is a system for controlling a host using a remote control whose functions are defined by that host. Functions on the remote control are arranged by the host and grouped logically for easy navigation. The communication between the remote and host is bi-directional, and can occur in real time. The controlled devices can be devices for controlling applications within a home or within a commercial building.

### RELATED APPLICATIONS

Priority is claimed to Provisional Application Ser. No. 60/569,123 filed on May 6, 2004, U.S. patent application Ser. No. 10/841,581 filed on May 6, 2004 and U.S. patent application Ser. No. 10/840,925 filed on May 6, 2004.

### TECHNICAL FIELD

The present invention relates generally to the field of remote control devices and, more particularly, to a hand-held remote control for a modular audio/video (A/V) apparatus or for other remotely controllable apparatus.

### BACKGROUND

In recent years, there has been a vast proliferation of the amount of consumer oriented audio and/or video equipment for use mainly in private residences. There has also been a proliferation of other controllable systems, both for private residences and for commercial enterprises.

Remote control devices for these remotely controllable systems are difficult to use because the remotes require updating when new components are added to the controllable system. The current state of the art can be described as either one remote control per device; or a universal remote control that must be taught the correct command sequence for a particular controllable system or device. The remote control device of this patent supports the features that are contained within a controllable system even as those features are updated or added to, simplifying user control considerably. These controllable systems will sometimes be referred to as the controllable “host” or the “device.” Also, the processor or other computational component or a particular other module within the modular entertainment center or other controlled system may actually be the “host” or “device.”

### SUMMARY

Remote control devices currently fall into the category of “necessary evil” for most users. Users either have multiple remote controls for one remotely controllable system, or a universal remote that they have had to teach to perform multiple functions, a time consuming and tedious process. The bi-directional remote control of this patent will receive control information from the host. The control information identifies the controllable the components in the host and provides information for controlling those components. The remote can store that information and display it on a touch screen on the remote control. The user then navigates the touch screen, sending control information back to the home entertainment center, which then operates in accordance with the control information sent by the remote control.

We also disclose a bi-directional remote control method for controlling the controllable system in an intuitive manner using the remote control. The remote control can be simplified from the traditional maze of buttons to a simple touch screen, with nested display screens organized by logical functions, based on the controllable modules that are contained in the host. This is made possible by the modular nature of the device or system being controlled; the controllable system can determine which functions are installed in it, and can efficiently communicate what those functions are to the remote control, which the user then uses to control the functions of the controllable host. Stated another way, the remote will communicate with the host, which “knows” what features it, the host, contains and can support. The host will then communicate with the remote control to cause the remote to be reconfigured based on the available, controllable components and features of the host. The user then manipulates the reconfigured remote control to control the components or functions of the controllable system. This will result in a simple to use, self-configurable remote control. The control information for the remote control can be arranged principally in terms of logical function. By “principally” is meant the “Watch,” “Listen” (and other functions) paradigm described in this patent. Current remotes are based on device, such as “control your DVD player,” “control your TV set,” “control your amplifier”—each as a device. The information for our novel remote ultimately gets down to devices but the top level, or principal, organization is by logical function-watch, listen, etc. Further, there could be various levels of abstraction of the functional information. For example, “live TV” could be a combination of local broadcast channels and satellite TV, which can exclude local channels.

The concept of the remote control device is flexible, also. A cell phone or Personal Digital Assistant (PDA) could be programmed to recognize a host. This leads to the situation where a single host can recognize multiple controlling devices. Conversely, multiple hosts, including devices outside of the field of home entertainment, could be recognized by a single remote. A methodology for ensuring that each available host is properly controlled is described in detail.

As described above and below, the host serves the function of a traditional multi-box home entertainment system, and the remote is a display device for that system. This system integration enables novel features not currently supported by a traditional home entertainment system. A simple example is changing surround modes in an amplifier automatically based on the genre of music being played. When a “Jazz” song is played, the amplifier changes to “Jazz” mode setting automatically; when a DVD is played, the amplifier would change to “Movie Theater” setting.

A more complicated example of an enabling technology described below is the application of parental controls across all content sources controlled by this device. For example, based on settings contained within the host, an individual teenaged user would not be able to watch “R” or “NC17” rated DVDs, watch live or recorded TV shows rated “TV-MA”, listen to CDs, MP3s, or satellite radio labeled as “Mature”, play games rated as “Mature,” or order Pay per View or video on demand services.

Finally, it is recognized that individual users may wish to integrate their host device with third party hardware, such as a TV monitor, Video Cassette Recorder, external audio amplifier, or other device. A method to integrate third party hardware within the paradigm of the described remote control method is discussed in detail, ensuring ease of use for the consumer.

### BRIEF DESCRIPTION OF DRAWINGS

These and further features of the present invention will be apparent with reference to the following description and drawings, wherein:

FIG. 1 is schematic representation of a modular A/V assembly.

FIG. 2 is a block diagram of a modular A/V assembly.

FIG. 3 is a generalized block diagram of the bus structure of the A/V assembly.

FIG. 4A is a more specific block diagram for an embodiment of the A/V assembly using the Philips PNX 1500 or 1700 series processor as an example of the CPU used.

FIG. 4B is a more specific illustration of FIG. 4A showing components of the video processor that can be used as the audio/video source selector/multiplexer of FIG. 3.

FIG. 5 shows the appearance of the front of the modular A/V assembly.

FIG. 6 shows the appearance of the rear of the modular A/V assembly.

FIG. 7 demonstrates one embodiment of the modularity aspect of the modular A/V assembly.

FIG. 8 illustrates the control portion of the remote control by the modular A/V assembly.

FIG. 9 illustrates the initialization and sequence that the host performs on power up.

FIG. 10 is a basic flowchart for the communication between the remote and the home entertainment center or other controllable system.

FIG. 11 is a representation of the “Home” screen for the remote.

FIG. 12 illustrates the screens that would be loaded from the “Home” screen selection of FIG. 11.

FIG. 13 illustrates the screens that would be loaded from the “Watch” page shown in FIG. 12.

FIG. 14 shows the detail of a sample control screen, in this case the “Broadcast TV” page.

FIGS. 15A and 15B demonstrate the differences in configuration based on the installed components in a host device.

FIG. 16 is one simple rendering of the remote control's appearance.

FIG. 17A through FIG. 17C illustrate several variations on the fundamental design of the remote control device.

FIG. 17A, illustrates the touch screen as the only interface to the user or the host.

FIG. 17B illustrates the addition of common commands such as channel up-down, volume up-down, mute and power, located across the bottom of the screen of FIG. 17A.

FIG. 17C illustrates, as buttons, the commonly used functions that were introduced in FIG. 17B.

FIG. 18 describes how to set up third party hardware to be controlled by the host device.

FIG. 19 describes how the host identifies third party hardware from a library of known devices.

FIG. 20 describes how to teach the host commands for third party devices for devices not contained in the standard library.

FIG. 21 details specific screens displayed on the remote while learning commands for third party devices.

FIG. 22 is a diagnostic flowchart to aid in troubleshooting if installation of third party hardware is not successful.

FIG. 23 shows the appearance of display screens when the remote recognizes multiple devices that it can control.

FIG. 24 describes the procedure for multiple users of the same remote, enabling parental controls based on user.

FIG. 25 details the hierarchy of access controls to the device.

FIG. 26 details the decision making process in determining whether content should be displayed based on the current settings of the host.

### DISCLOSURE

Modular A/V Apparatus as the Controllable System

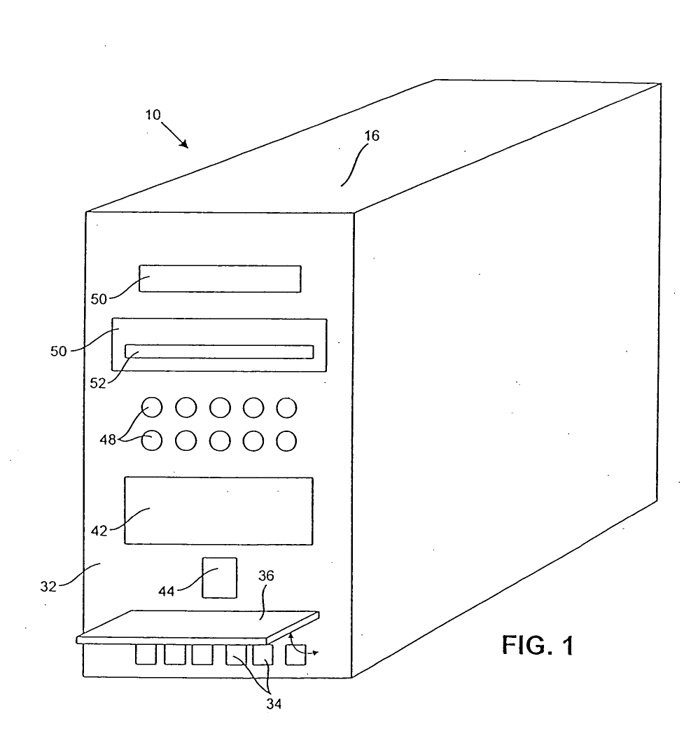

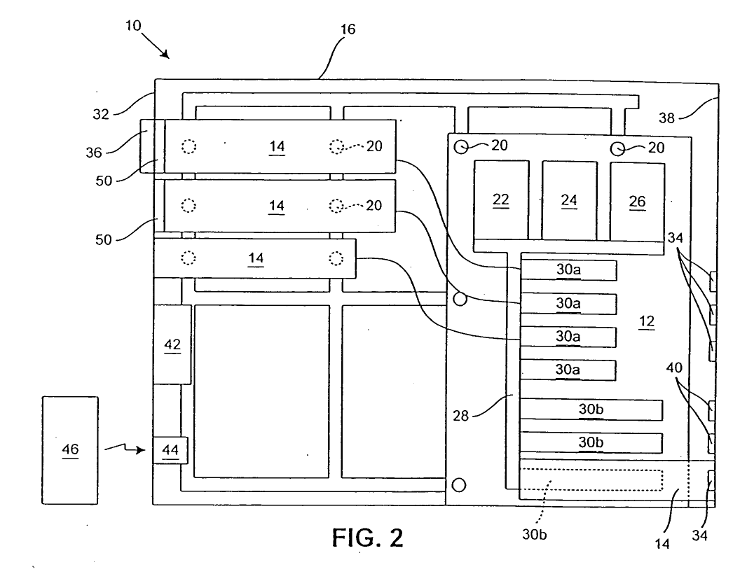

Referring to both of FIGS. 1 and 2, shown is an example embodiment of a modular A/V apparatus or assembly 10. FIG. 1 depicts a schematic representation of the assembly 10 and FIG. 2 depicts a functional block diagram of the assembly 10. Accordingly, FIGS. 1 and 2 are functionally consistent with each other, but the size, location and arrangement of corresponding components may not be shown with consistency from view to view.

As used herein, the term A/V is intended to refer to audio and/or video content, such as in the form of one or more of audio files, audio signals, video files, video signals, combined audio and video files, combined audio and video signals and combinations thereof. Therefore, the term A/V assembly refers to an apparatus capable of performing at least one A/V management function or task, such as the examples of storing, playing, editing, receiving, decoding, encoding, amplifying and transmitting A/V files and/or signals.

The modular A/V assembly 10 is a user upgradeable, modular platform for managing A/V content, including without limitation audio files and signals and/or video files and signals. It is noted that most video files and signals contain both a video component and an audio component, but will be referred to herein simply as video files and signals.

The assembly 10 has a main board 12 with a set of standardized interface features. In one embodiment, one or more modules 14 are provided. The modules 14 can be operatively coupled to the assembly 10 by the standardized interfaces of the main board 12. Each module 14 can perform one or more dedicated A/V tasks and can be added, removed or replaced as desired by a user of the assembly 10. In this manner, the assembly 10 and the A/V functions performed by the assembly 10 can be configured and reconfigured with a high level of flexibility.

The main board 12 can comprise a circuit board that is mounted in a housing, or chassis 16. For example, the chassis 16 can include an internal rack 18 to which the main board 12 is mounted with any suitable fastener, such as screws 20.

The main board 12 can include a video processor 22, such as a NEXPERIA PNX 1500 available from Philips Semiconductor, or any other suitable processing device for executing programmed logic instructions. In other embodiments, the processor can be a commercially available general use processor or an application specific integrated circuit (ASIC). The processor 22 can execute software routines to facilitate interaction with and among the modules 14. In addition, the processor 22 can execute software routines to carry out A/V management functions, to edit A/V files and signals, transcode A/V files and signals, convert video files and signals from 2D representations to 3D representations, and any other A/V processing.

Support circuitry and devices for the processor 22 can be included on the main board 12. Support circuitry and devices can include, for example, a memory 24 (e.g., RAM and/or ROM components), an A/V multiplexer 26 and/or a local interface 28 to operatively connect components of the main board 12. The memory 24 can store operating instructions in the form of code for execution by the processor 22. The code can comprise a set of operating system instructions and/or specified logic routines for carrying out specific functionality of the assembly 10. The memory 24 can also store data, various software programs and/or logic routine instructions, files and the like. In some embodiments, the memory 24 can also store A/V files and signals. Although illustrated with a single block, the memory 24 can comprise several devices and includes, for example, volatile and non-volatile memory components. Accordingly, the memory 24 can include, for example, random access memory (RAM), read-only memory (ROM), a hard disk, a floppy disk, a compact disk (e.g., CD, DVD, etc.), a tape, and/or other memory components, plus associated drives, writers and players for these memory types.

The processor 22 and the memory 24 can be coupled using the local interface 28, which can be comprised of a data bus with an accompanying control bus, a network, or other subsystem. The A/V multiplexer 26 can switch a desired video signal and/or audio signal from one of a plurality of sources to the video processor 22 over the local interface 28. The main board 12 can further include a video encoder (not shown) to encode signals output by the processor 22 and/or a video decoder (not shown) to decode signals transmitted to the processor 22.

The main board 12 can include a plurality of interfaces 30 for physically connecting the modules 14 to the main board 12 and operatively connecting the modules 14 to the local interface 28 and processor 22. In one embodiment, the interfaces 30 are physically and functionally based on a standardized format, such as peripheral component interconnect (PCI), industry standard architecture (ISA), or other peripheral interface standard adopted from the general purpose computing arts. Some of the interfaces 30a can be configured to physically connect to cables or wiring harnesses associated with the modules 14. Other interfaces 30b can be configured to physically connect to edge connectors of a card or board of the modules 14. For instance, the interfaces 30b can be embodied as PCI slots. It should be appreciated that the interfaces can be embodied with any suitable industry standard interface or a proprietary interface.

The modular A/V assembly 10 can also include a power supply (not shown) for supplying electrical power to the various components of the assembly 10, including the main board 12 and the modules 14.

As should be appreciated, the assembly 10 is configured with a desired permutation of A/V functionality by connecting modules 14 to the interfaces 30. The number of modules 14 and the function(s) performed by each module 14 can be selected by the purchaser or user of the assembly 10. For instance, the selection and installation of modules 14 can be carried out by the end consumer/user, by a vendor of the assembly 10 and/or by a manufacturer of the assembly 10. The assembly 10 can be custom built to order (e.g., with a set of modules 14 as selected by a purchaser) or with a default configuration as selected by the vendor and/or manufacturer. As indicated, each module 14 can perform one or more functions. Therefore, the modules 14 can include, but are not limited to, an analog and/or digital video tuner (or “TV tuner”) module, a cable box module, a repeater/emitter module for assisting in changing channels from a cable box or other device, a memory component module (e.g., hard drive or other data storage medium), an audio receiver (AM, FM, and/or satellite) module (optionally including an amplifier), a CD and/or DVD player and/or burner module, a digital video recorder module, a networking module(s) (e.g., an Ethernet card, a wireless adapter card, etc.), a peripheral input/output (I/O) interface module(s) (e.g., a USB port, a Firewire interface, a mouse interface, a keyboard interface, a Bluetooth or other wireless interface, a joystick interface, a video game control unit interface, a serial port, a parallel port, etc.), a portable memory reader module (e.g., a “memory stick” interface), an audio amplifier module, a video and/or audio interface module(s) with standard A/V ports (e.g., component ports, DVI ports, etc.), a video game player module, and combinations of these modules. Additional features and functions that can be embodied in one or more modules 14 are described below.

An aesthetic industrial design of the assembly 10 is preferred so that the assembly 10 can be showcased in a user's home entertainment center. For example, the chassis 16 can have smooth, flowing exterior surfaces. Connectivity aspects (e.g., jacks and connectors), or ports 34, (such as Firewire ports, A/V ports, USB ports, etc.) can be accessible from a front panel 32 of the chassis 16. In one embodiment, the ports 34 can be hidden behind a door(s) 36 or other feature. A rear panel 38 of the chassis 16 can have knockouts 40 (e.g., permanently removable covers or replaceable covers) so that various connectivity ports 34 of individual modules 14 can be selectively exposed. Additional connectivity ports 34 can be mounted on the rear panel. The connectivity ports 34 found on the front panel 32 and the rear panel 38 can be duplicative in nature. For example, industry standard video input/output jacks can be provided on both the front and rear of the chassis 16.

A display 42, such as an LCD panel, LED panel, or other illuminated panel can be provided on the front panel 32 to display information to the user regarding status of the assembly 10 and/or one or more of the modules 14. A receiver 44, such as an infrared (IR) receiver or a radio frequency (RF) receiver, can be provided on the front panel 32 to receive input signals from a remote device, such as a remote control unit 46. The remote 46 can have buttons, a display, and any other appropriate input/output components for interacting with the user so as to provide the user with at least partial control over operation of the assembly 10; however, the preferred embodiment of the remote control uses a touch screen and is detailed below. Similarly, user input devices 48, such as buttons and user input components, can be provided on the front panel 32 to provide the user with at least partial control over operation of the assembly 10.

Certain modules 14 can be mounted to be accessible from the front panel 32 of the chassis 16. For example, modules 14 can be attached to the rack 18 with brackets and/or fasteners (e.g., screws 20) to be positioned with respect to windows 50, doors 36 or knockouts 40 of the front panel 32. In one embodiment, CDs and/or DVDs can be inserted into a disk receptacle 52 (e.g., drawer or slot) of a module 14 through a window 50 defined by the front panel 32. In other embodiments, wires can be connected directly to a module 14 through the front panel 32 (e.g., through a window 50 and/or behind a door 36) and buttons of a module 14 can be accessible through the front panel 32 (e.g., through a window 50 and/or behind a door 36). Certain modules 14 can be accessible through the rear panel 38. For example, wires can be connected directly to modules 14 through the rear panel 38 (e.g., through an opening that was previously covered by a knockout 40). In other embodiments, certain modules 14 or portions thereof can protrude through the front panel 32 and/or the rear panel 38.

As indicated, the assembly 10 can be configured by a purchaser or end user of the assembly 10. For example, at the time of purchase, the purchaser can specify the features and/or specific modules 14 that the purchaser desires. Using the information gathered from the purchaser, a manufacturer or assembler of the assembly 10 can build the assembly 10 to meet the specified configuration. In one embodiment, the purchaser can select desired features, software packages and/or desired modules 14 using a client terminal (e.g., a general purpose computer executing a web browser) that interfaces with an Internet website hosted by a server. The Internet website can include menus (e.g., content specific selection menus, drop down menus, etc.), fields for the user to fill in, and any other appropriate user interactive features. In one embodiment, the user can specify functions that the user desires. Using the specified information, software executed by a computer of the manufacturer, with or without the assistance of a human operator, can generate a configuration of modules 14 and/or software programs (e.g., executable code to be “pre-installed” on the assembly 10) to implement the desired functions.

Once assembled, the assembly 10 need not be statically configured. For example, the purchaser, end user or service technician can add, remove and/or change functionality and/or modules by making corresponding changes to the modules connected to the main board. Other functionality can be added, removed and/or changed by making corresponding software and/or firmware changes to code that is stored by components of the main board 12 and/or the individual modules 14.

As should be apparent from the discussion herein, the modularity of the modular A/V assembly 10 exhibits several advantages over conventional A/V devices. For instance, the purchaser/user of the assembly 10 can custom arrange the assembly with modules 14 and/or executable software to carry out an exact set of functions of interest to the purchaser/user. This individual choice can result in the construction of an assembly having the features and functions desired by the purchaser/user and without undesired features and functions that may otherwise be present in “off the shelf” A/V equipment.

In addition, the amount of wire and tangling thereof can be reduced relative to conventional home entertainment arrangements by using the single chassis 16 having an internal bus structure to route most audio and/or video signals among various functional components.

The purchaser/user can also upgrade the assembly 10 after initial fabrication of the assembly by adding or replacing a module 14 or software component. Upgrading of the assembly 10 can allow for adding compatibility with a later developed technology, such as adding the ability to read a newly developed A/V storage medium. Upgrading of the assembly 10 can generally be carried out at a lower cost than purchasing an additional item of dedicated equipment. Furthermore, upgrading and/or changing a module 14 or software component can be carried out in a relatively straight forward manner. For instance, a purchaser/user who is familiar with installing a card in a PC and/or installing software on a PC ought to be able to perform upgrades and/or reconfigurations with minimal complications.

Additional advantages can be realized from other aspects of the present invention. For instance, the purchaser/user can order the assembly 10 directly from a manufacturer of the assembly 10, resulting in cost savings by establishing an end purchaser/manufacturer relationship. Parties other than the original equipment manufacturer of the assembly can create hardware modules 14 and/or software components for the assembly 10. Such third party components should have a high degree of compatibility with the assembly 10 due to the open architecture of the assembly 10 and, specifically, the use of standardized interfaces 30 for module 14 connectivity.

When ordering an assembly 10 from a manufacturer, the purchaser can be presented with options regarding which specific features and functions from various groups of features and functions will be represented in the purchaser's customized assembly 10. For instance, when ordering the assembly 10, the purchaser can be given the option to order a hard drive module or other memory component as part of the assembly 10 and, if the memory module is selected, the data storage capacity of such a memory. The purchaser can also be given the option of including a TV tuner with the assembly 10.

Additional categories of features and functions that can be embodied as a module 14 and/or software components can include input/output interfaces for, among other functions, transferring data, user input device interfaces, video functions, video input/output interfaces, and audio functions. The input/output interfaces can include, for example, a USB interface, an Ethernet Card, a Firewire interface, a portable memory (e.g., a “memory stick”) interface, a smart card interface/reader and a USB master. The user input device interfaces can include, for example, a mouse interface and a keyboard interface. The video functions can include, for example, a DVD player, a DVD burner, a cable tuner, a digital TV tuner, a second or auxiliary RF or TV tuner, a cable box controller (e.g., emitter/repeater), and a digital video recorder (e.g., a DVR). The video input/output interfaces can include, for example, RCA connectors, component video connectors, DVI connectors, co-axial cable connectors, HDMI connectors, and HD15 (VGA) connectors. The audio functions can include, for example, an audio tuner, an audio amplifier, a digital audio receiver, a CD player, a CD burner and an MP3 player.

Larger assemblies can be constructed using the modular A/V assembly 10. For instance, the assembly 10 can be coupled to a television (not shown) for displaying video signals output by the assembly 10. The video signals output by the assembly 10 can originate from a storage medium that is read by a component of the assembly 10, a broadcast that is received by a tuner of the assembly 10, or an external device that is connected to a video interface of the assembly 10. Other devices that can be connected to the modular A/V assembly include, for example, a video game player, a still camera and/or video camera, one or more speakers, a general-purpose computer, a portable audio file or video file player, and so forth.

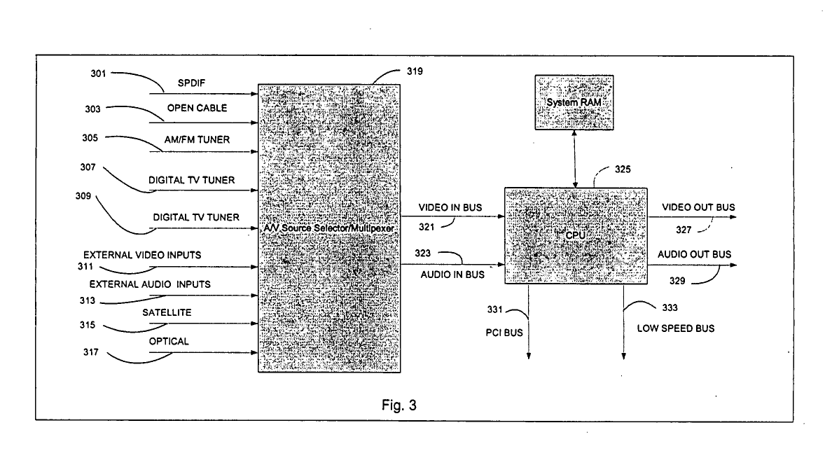

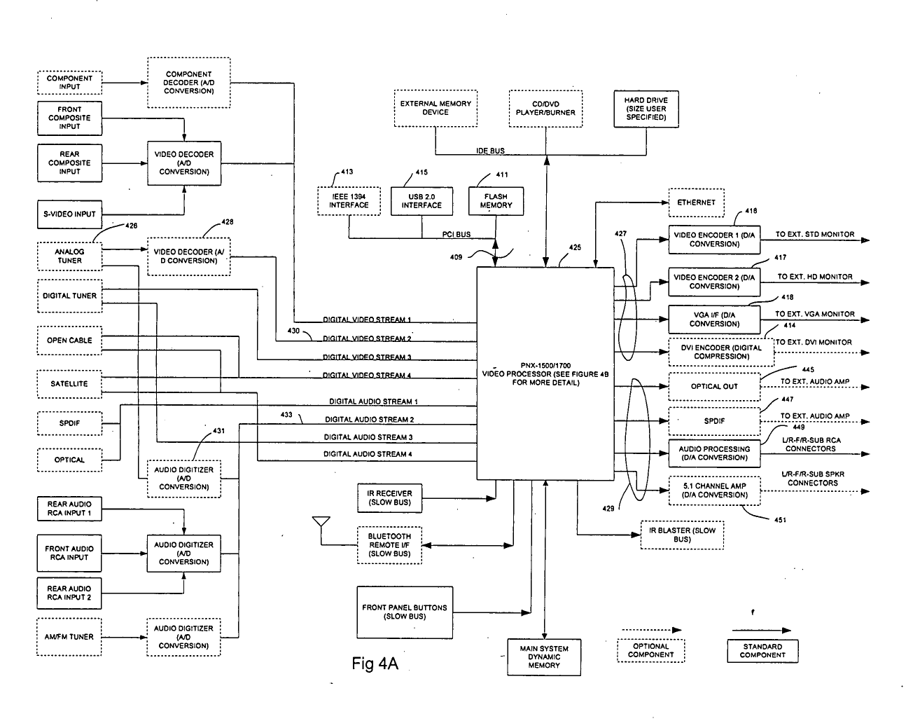

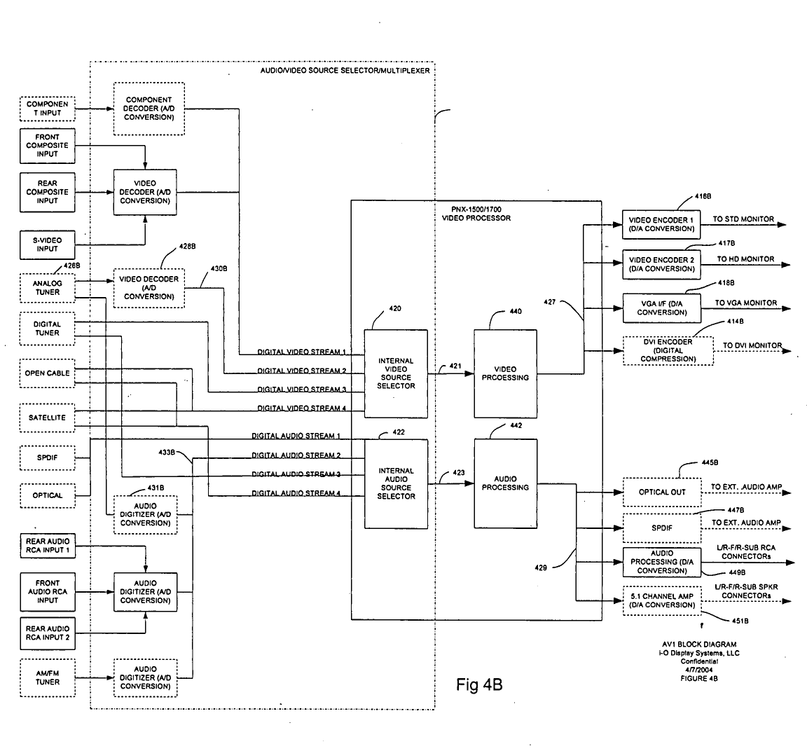

Referring to FIG. 3, the electrical bus structure of the modular A/V assembly or system is illustrated. The bus structure is very simple and designed with both modularity and audio/video processing in mind. This bus structure comprises:
A central processing unit 325 which may be a video processor;
Multiple A/V input sources or components 301, 303, . . . 317. Not all of these sources may be present or active simultaneously, but if more than one source is active, there should be a way for the device to select the correct source for both audio and video;
Two input buses to CPU 325—one for audio, audio bus in 321, and one for video, video bus in 323. These buses feed the data stream to be processed into the video processor 325;
An audio/video source selector/multiplexer 319 to select the appropriate A/V input source(s) for the user. The A/V input sources are connected to the A/V source selector/multiplexer 319 which selects the correct source to be processed by CPU 325 and puts the correct source on audio bus in 321 and video bus in 323;
A “fast” PCI bus 331 that can be used to stream data into or out of the assembly at speeds faster than real time video;
A “slow” or low speed bus, 333, that is used to transmit small volumes of data such as HTML that may be used to run the remote control;
And, finally, the video out bus 327 and the audio out bus 329. These buses 327 and 329 are coupled to audio/video destination components such as monitors, audio amplifiers, and speakers as shown in FIG. 4A and as indicated in FIG. 4B, and to other destination components for which the manufacturer or user may design the system. Since the destination for audio and video are different, these buses should be independent of each other. The modular A/V assembly can be considered a host for audio/video components having controlled functions and, more particularly, the processor 325 within the modular A/V can be considered the host.

FIG. 4A shows a block diagram of an implementation of our modular A/V assembly using the Philips PNX 1500 or 1700 series of processors, 425, as CPU 325 of FIG. 3. While there are some differences with FIG. 3, the two diagrams, FIG. 3 and FIG. 4A, are functionally equivalent. Optional components are shown dotted in FIG. 4A. These components may be factory installed, installed by authorized service agents, or installed by the user. The determination as to whether a component is optional or standard will be based on cost, desirability of feature, and whether that feature is commonly standard in that particular class of equipment.

FIG. 4A has a number of input sources, just as FIG. 3 has. FIG. 3 shows these sources going into A/V source selector/multiplexer 319 and arriving at CPU 325 as a single source.

As can be seen in FIG. 4A, the following components reside on the PCI bus 409 that was shown at 309 on FIG. 3: flash memory 411; IEEE1394 (Firewire) 413, and USB 415. The latter two are fast transport mechanisms so that data can be streamed into or out of the apparatus at speeds much faster than real time video. For example, a ninety-minute DVD resolution movie can be copied over USB 2.0 in approximately 8 minutes.

The slow bus is not explicitly shown in FIG. 4A because of the multiplicity of devices that use this bus. The slow bus is used to communicate with buttons, IR remotes, Bluetooth, and the like. The slow bus may be I2C, parallel, or other bus protocol.

The Video Out bus 427 is shown in FIG. 4A going to three video encoders; one encoder, 416, can be for standard video; a second encoder, 417 that can be component video, a third component 418 for VGA output; and an optional component such as DVI encoder 419 for a digital high definition display. Similarly, the audio out bus 429 can be routed to both standard and optional components such as audio processor and amplifier 421 and 5.1 channel amplifier 422, respectively. The arrows leaving the video and audio sections on the right go to an external device that is not covered under the scope of this patent. Alternatively, and as an option, cabling can be provided to allow the user to connect his or her own, more expensive, audio processor and amplifier into the system. This can be done in either the analog or the digital domain, although either can detract from the all digital architecture of the assembly that is described below. Degradation is clear for analog. Optical or SPDIF are digital, so the quality can be as good as the all internal design. However, there is a risk here of signal degradation from ground loops, bad connections, or the cable acting as an antenna.

The bus architecture outlined in FIG. 3 enables modularity of the design. The main board will have a number of openings for modules to be added. These modules may be slots, like in a PC, or they may be bays, as explained below. In any event, there is an interface on the main board for these modules to plug into. The interfaces for the modules will be routed with up to all six buses, the (fast) PCI bus 331, the low speed bus 333, the video in bus 321, the audio in bus 323, the video out bus 327 and the audio out bus 329, depending on the function that receptacle is used for. For example, some receptacles will be general purpose, and have all six buses routed to them. Other receptacles may be for a specific function, such as an external memory device, and so only need to have the fast bus 331 routed to it.

FIG. 4A also shows a novel, all digital architecture. The analog tuner module 426 is an optional feature. The audio and video signals are split apart within the tuner itself. The video signal is digitized via video decoder 428 and connected to the processor 425 via the Digital Video Stream 2 line. Similarly, the audio signal can also be digitized, via audio digitizer 431, and connected to the processor by the Digital Audio Stream 2 line. Thus, because of being digitized, the incoming analog audio and video signals are at the highest quality achievable when they arrive onto the main board. Alternatively, these signals may already be digitized when they enter the assembly. These include digital broadcast TV received through a tuner module, Digital Cable or Satellite. An analog to digital conversion is not required for these inputs. Similarly, there may be some outputs that are digital also such as DVI to the monitor, Optical or SPDIF to the Audio. Prior art apparatus use cables, typically analog, to connect various functions. Each analog connection made using cables can degrade the signal in a number of ways: converting between the analog and digital domain repeatedly; downscaling the resolution of the image; introduction of noise from connectors; introduction of noise from external radiation caused by cables acting as antennae; introduction of ground loops if all components are not properly grounded. The all-digital internal design essentially solves all of these problems. In this regard, the ultimate in retaining fidelity would be to have only the power cord and the speakers be analog.

A more specific illustration of FIG. 4A is seen in FIG. 4B. This figure more specifically illustrates taking advantage of multiple inputs available on the PNX chip. Thus, the audio/video source selector and multiplexer 319 of FIG. 3 is broken into several components in FIG. 4B that are contained both inside and outside the CPU chip 425 (which chip provides the CPU function illustrated at 325 in FIG. 3). The audio/video source selector/multiplexer 319 of FIG. 3 is seen in dash line format at 419 in FIG. 4B. Thus the audio/video source selector/multiplexer can, if desired, use some of the components of the CPU chip or it can be a separate unit 319 as seen in FIG. 3. It can be appreciated that this bus architecture does not necessarily link an audio and video source. The video and audio input sources are independent of each other. One feature of this independence is that the architecture of the device enables Digital Video Stream 4 line (for example) to be on the video in bus (321 of FIGS. 3 and 421 FIG. 4B), while Digital Audio Stream 2 line (for example) is on the audio in bus (323 of FIGS. 3 and 423 of FIG. 4B), simultaneously. This can be accomplished by selecting the appropriate digital video stream via internal video source selector 420 and selecting the appropriate digital audio stream via internal audio source selector 422. From a practical standpoint, this allows a user to watch a TV broadcast of a ball game while listening to the local radio feed of the same ball game. As used here, the term “broadcast” is not limited to television or radio broadcast, but could be Internet, intra net, intra- or inter-community or intra- or inter-company broadcast or similar communication. As another example of this feature, the user can listen to a local radio station while displaying JPEG images from a hard drive or external source.

The user would access the above feature through the remote control. An example of how this would work is as follows: the user would select a video viewing option. The audio would be the default source. However, the user would have the option to select an “alternate audio source” on the remote control. Selecting this option would display the audio sources available and allow the user to select one of these. A more sophisticated embodiment would allow the user to delay either the audio or video source to sync them up properly.

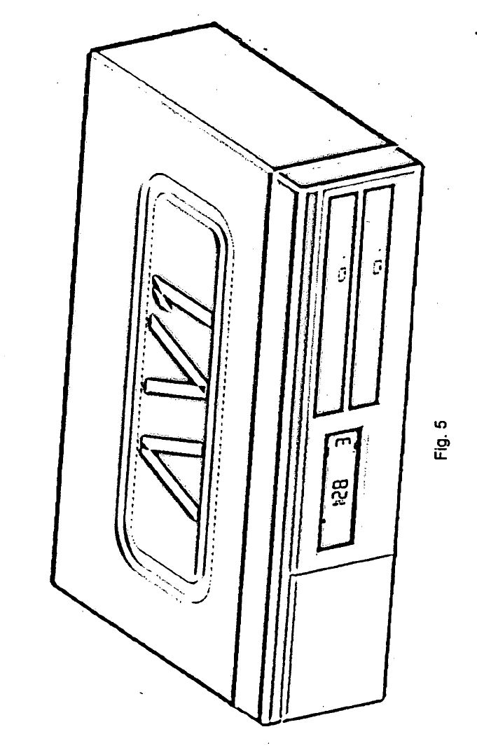

FIG. 5 shows the front of the apparatus. On the left hand side is a door that hides connections that are desired on the front of the device but that are not aesthetically pleasing. These include Firewire, USB, external memory devices, and analog A/V inputs. In the center is a display like those commonly seen in home A/V equipment. On the right in this example are two bays. This may serve many purposes: for example, a user may want to have two CDs that play sequentially for ease of use; a user may have a CD burner and DVD drive in the two bays. Another possibility is a split in video standards, similar to that which happened with BetaMax and VHS in the early days of home video. One bay could support each of the DVD replacement formats so that the user does not have to invest heavily in hardware that the marketplace may doom shortly.

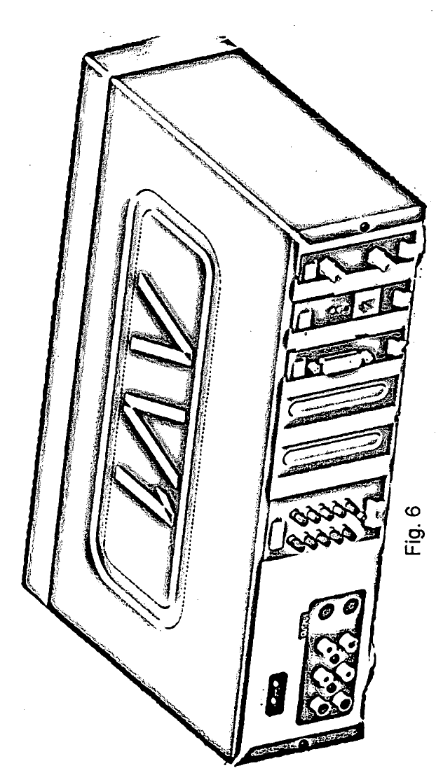

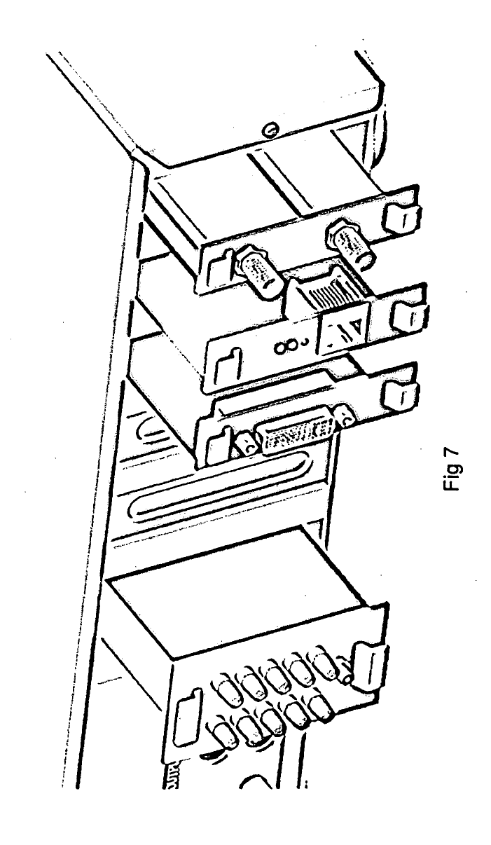

FIG. 6 shows the rear of the apparatus. On the left are standard outputs that are built into the device. On the right is a series of bays. FIG. 7 is a close-up of the bays, showing four modules in bays, and two unused bays. While slots are common in computers and are a potential embodiment of the device, the bays have a number of significant advantages over plug in cards. These include:

Safety: the user cannot access high voltage components, as he can when opening a case to replace a card.

Convenience: The user can accomplish the addition of a module much more quickly than a card.

Reliability: Often, cards do not seat properly. A module that slides in would create a more reliable, consistent connection.

Hot Swappability: The ability to add or removes modules from the bay while under power can be accomplished. The module is designed to lock into place mechanically. This locking mechanism would have a switch. Locking the mechanism would close the switch. The device would detect that a module has been added and apply power to it in a manner that will prevent it from being damaged. Similarly, when the locking mechanism is opened, the switch will open, and the receptacle will power down prior to removal.

From a functional standpoint, the device can respond to the addition of a module in one of two ways:

The first option is to recognize the new hardware. Since this hardware must be initialized, and initialization occurs at startup, the device would power cycle itself automatically. It would turn itself off, then reboot or power back up. During power up, the device would initialize the new hardware in accordance with its particular initializing procedure, load the appropriate drivers, and, if an Internet connection is available, possibly go to a website and check for newer versions of the driver for the hardware module.

The second option is to allow the user to control the timing of the reboot. Thus, power is not applied to the card and it is not initialized until the user power cycles the device. A message asking if the user wants to power cycle the device may appear on the screen and/or remote control so that he is informed that the device must be turned off for the new module to be recognized.

One further novel aspect of the device that the modularity enables is a very simplified remote control user interface. A conventional remote control has fixed functions and so does not work well with a modular, upgradeable host. Two control methods are discussed below:

The first remote control method requires the host to have two-way communication with the remote. This can be accomplished with Bluetooth or some other well understood wireless technology. The remote control is seen in application Ser. No. 60/534,503 filed Jan. 6, 2004 and assigned to the common assignee. It is essentially a touch screen that displays a series of options from which the users can choose. This menu of options is sent by the host. In the typical case the menu of options is sent at one time to the remote. However, in other cases, the device may send commands one level deep for rapid display. Examples of when this may occur include:

For use with a cell phone, PDA, or other device. These devices may not have sufficient memory available to store the entire menu of options. Furthermore, these devices may “flush” their memory when they leave the range of a host device. Uploading the entire set of commands can be time consuming, taking over a minute. The alternative is sending screens one level deep for rapid display is more time and memory efficient.

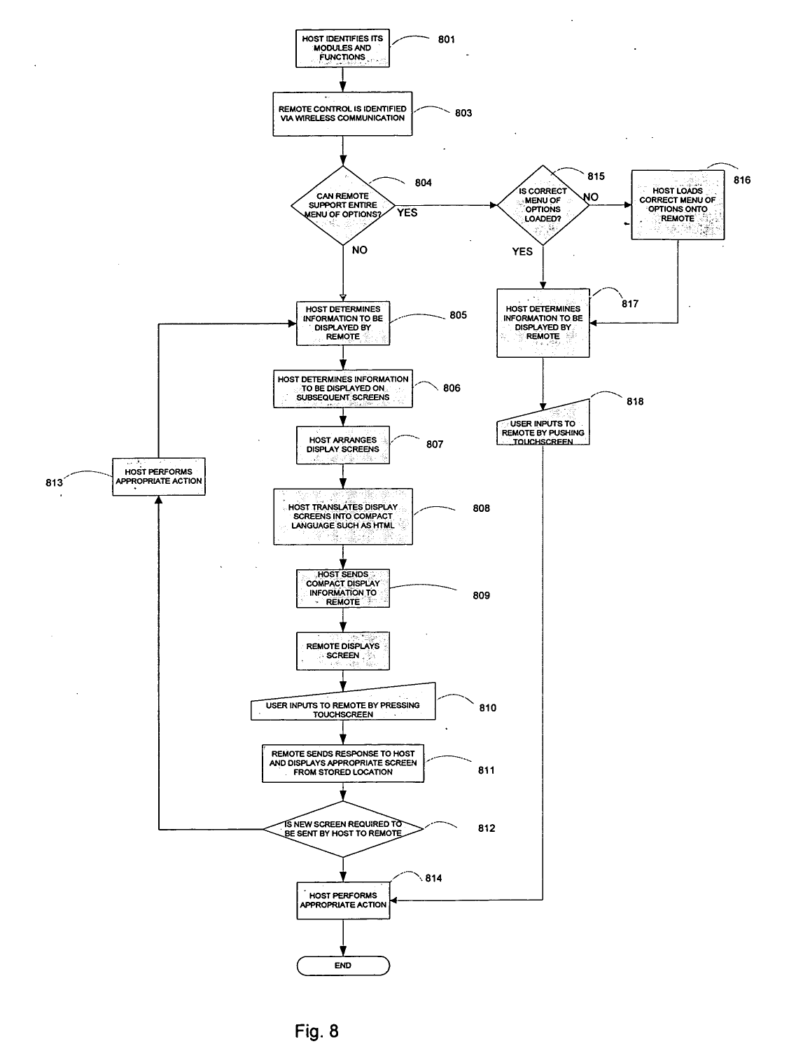

For use during troubleshooting and diagnostics. These operations have high memory storage requirements because they are highly interactive, can be very technical, and have large numbers of branches to select from. In addition, they are infrequently used. Thus, these functions may also be sent only one level deep. In FIG. 8, a host/remote interface is shown. For reasons of simplicity, the very basic case is demonstrated, with a single remote talking to a single host, and with no access (parental) controls applied. Both communications methods are discussed.

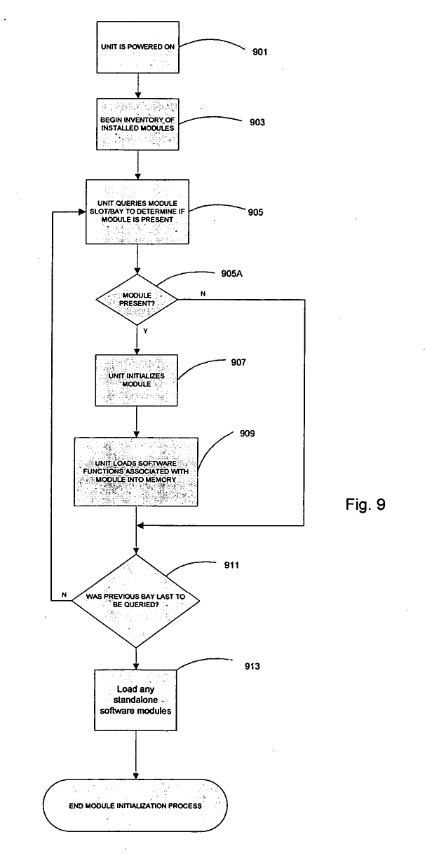

As seen at 801, the host identifies its own modules and the functions that those modules support. FIG. 9 shows the steps that the host takes to accomplish this function. The host begins the process upon application of power 901. The assembly is modular; thus, the host does not know which modules are present in particular interfaces when the assembly is first powered up. A module can be hardware or software, and includes the option for controlling third party hardware. The assembly has a known number of hardware interfaces, usually one for each bay. The host begins to inventory the installed hardware modules, bay by bay, at 903, and at steps 905, 905A queries these bays sequentially, which can be done by querying each interface. If a bay is empty and step 911 shows that the previous module was not the last one that is to be queried, the host queries the next interface or bay by proceeding again through the loop as at 905, 905A. If an interface is occupied, as seen at the “Y” exit of step 905A, the device interrogates the card contained in that interface to determine its type and, as appropriate, its configuration information, as at 907. This can be termed “initializing” the module. Once the type of card is known, the device loads the appropriate software modules for that card into memory as at 909. This step is included because the user may have purchased after market software that is associated with a particular card. For example, the user may have purchased an advanced video editor for home movies at the time that a Firewire card is purchased. After the hardware modules are loaded, the standalone software modules are loaded (913). This step could also be performed prior to the querying of the hardware bays, since these modules are, by definition, independent of the hardware modules installed.

After the host has completed this inventory process, the host knows the hardware modules that are installed, along with their associated software programs. This inventory of installed modules can be stored so need be done only once per power cycle, and so need not be done again when the device is woken up from a power conserving sleep mode.

While the foregoing inventory process has been described in terms of a sequential process, it is well know that with the foregoing teaching the process can be implemented by a parallel process using hardware to store the installation status of each receptacle and the identity of each installed audio/video component, and inventorying or interrogating this hardware in parallel. Likewise interrogating the installation status of each receptacle and the identity of each installed audio/video component partly in parallel and partly sequentially does not depart from the scope of this invention.

In step 803, the host detects that the remote control is active in the vicinity of the host. This can be done by infrared detection, through Bluetooth, Zigby, 802.11, or other well known means. To conserve power, the remote may be in the vicinity of the host but not always active. The term “active” means any signal that the remote control is ready to receive or send information. It may simply be a request transmitted by the user depressing a “send” key on the remote control to send a request, as well as other well known infra red, Bluetooth, or other technologies.

The remote is activated by pushing a button or touching the screen. Upon activation, the remote will display a screen that is stored internally. This screen may be a startup splash screen for a cell phone or PDA, a “Home” screen for a dedicated remote if the host is turned off, or it may be the screen that was on the remote at the time that it became inactive. The relevant feature is that the act of displaying the screen upon activation is done from the internal memory of the remote, and not sent from the host.

In step 804, the host determines if the remote can support the entire menu of options. If it can, it branches to 815, where it determines if the correct menu of options is loaded. If it is, then the host determines the correct screen to be displayed on the remote (Step 817), and user can interface with the remote (Step 818). This interaction can be a through a single command or series of commands, at the end of which the host takes an appropriate action (814). If the correct menu of options is not on at the remote at Step 815, then the correct menu of options is loaded in Step 816 and the above process is rejoined at Step 817.

If it is determined in Step 804 that the entire menu of options cannot be supported by the remote, then the set of options must be sent to the remote sequentially in a bi-directional fashion. In Step 805, the host communicates with the remote to determine the current screen that is displayed on the remote. This can be accomplished by sending a unique identifier with each screen to be displayed. This identifier is a digital word that may have a fixed or variable number of bits. In a simplified case of a four bit word, the remote would broadcast “1111” upon startup to indicate that it is displaying the startup screen. The host may respond by sending the identifier “0000” for the screen to be displayed, followed by the compact language version of the screen. The remote would display the screen it just received and broadcast “0000” to indicate the screen that is being displayed.

In the case above, the identifier is sent before the single screen. In the actual application, the identifier may be sent before and/or after the screen.

Additionally, the case of multiple screens being sent in a sequence must be considered. In this case, the identifiers for the multiple screens may be sent before and/or after a particular screen, as detailed above; or the identifiers may be sent in list form as a series of pointers to the corresponding screens. This series of pointers may be sent before and/or after the data for the screens.

In Step 806, the host determines the subsequent screens to be displayed on the remote control based on the state in Step 805 and hardware and software modules that are loaded on the host.

If the remote control is displaying its startup screen (that can be loaded from internal memory on the remote) then the host will know that it needs to send the remote control a screen known as the “Home” screen. This screen is the starting point for the use of the remote. In this particular case, the remote also prepares, or arranges, the subsequent screens to the Home screen as at 807. This step gets the host ahead of what is displayed on the remote control, enabling the rapid display of subsequent screens.

If the remote is displaying a screen other than the startup screen, then communications have occurred previously between the remote and the host. The subsequent screens that are to be displayed are based on the options that are available on the screen that is currently displayed on the remote, as well as the hardware and software modules contained in the host.

The goal of this step is to identify what options the user may select next, and send the screens that are the response to these possible inputs (to the remote) to the remote so that it can quickly display the information to the user.

In step 807, the host can also format the relevant information for the subsequent display screens in a logical manner. This logical manner may take many factors into account:
a. The display screens can be formatted in a consistent manner—for example, with a description of the function in the top center, the “BACK” button in the same location, a universal layout for keypads, and the like.
b. Common functions should be grouped together. For example, “Channel Up” and Channel Down” should be located near each other.
c. Functions that are more frequently used may take a larger and/or more prominent display space than less commonly used ones. A given remote display screen may appear differently on two identically configured machines based on the usage patterns.

Examples of steps a and b, above can be seen in the copending application cited above.

Examples of step c above are given here:

In the first case, the host can base the display information on universal viewing habits. In other words, the host looks at which features have been accessed by the remote, how frequently those features are accessed, and how recently they have been accessed to determine which functions are used most frequently.

This can be accumulated and stored at the host or, given sufficient memory, can be accumulated and stored at the remote control for query by the host.

For example, two identical hosts in two locations have identical features: a DVD player, a hard drive and a tuner. The owner of the first host may watch mainly DVD movies, while the owner of the second host watches over the air broadcast over the tuner most often. The first host device may broadcast to its remote control the source selection screen with the area to select the DVD at the top of the display and consuming the majority of space. The second host device may broadcast the source selection screen that has the tuner selection most prominently displayed.

In the second case, a single host may base the screen configuration on an individual user's use preferences. For example, users could be tracked by I.D. or password and the home screen may consist of user names. Each user's preferences can be tracked as explained in the paragraph next above for universal viewing habits. The display screen is formatted in the manner explained above, but for each individual user, rather than for the entire host device. Furthermore, access to features may be limited based on the user. A young user may not be able to enter the “Setup” “Record” or “Move Data” functions. This will be discussed in greater detail in the “Access Control” section.

The user selection of the remote may be password protected, enabling parental controls. A first adult user of the remote may have full access to the sources. A second adult user of the remote may have access to all features except pay per view. A third teenage user of the remote may not have access to any content rated “R” or “TV-MA”; and so on. This also will be discussed in greater detail in the “Access Control” section.

In step 808, after formatting the information, the host translates this display screen into a compact language format such as HTML for transmission to the remote control.

In step 809, the host then sends this compact display information to the remote control, which stores this information for possible display by the remote control. This transmission can be accomplished through means that are well understood, such as Bluetooth or 802.11.

At this point in the process, the following has been accomplished: a display screen that the user can interact with is on the remote control, and the screen that will be displayed for any option the user chooses is stored on the remote control to be rapidly displayed.

At this point, step 810, the user selects an option on the remote control. The remote performs two functions, as described in step 811: The remote sends the response back to the host and displays the appropriate screen from internal memory (based on the user selection) on the remote. The response to the host can be sent as an XY pick location, or in other form.

The host then can make the determination as to whether there are additional subsequent screens to be sent to the display. An internal flag can be set for each screen that indicates if there are subsequent screens. The screen architecture can be top down; every screen that can be selected can be traced ultimately to a last screen, whose selections cause the host to perform an action.

If no subsequent screens are required, the host performs the requested action. Examples of such requested actions include changing the channel, adjusting the volume, fast forwarding video, etc.

If additional subsequent screens are required, as shown by the Y, or “Yes,” decision out of step 812, the host performs the appropriate action (if any) at 813 and then returns to step 805 to determine the subsequent screens that are to be displayed. An example of this would be if the user selects “Cable” as the source of video. In this case, the appropriate action is to switch the Cable Audio stream onto the Audio In bus, and the Cable Video stream onto the Video In bus. In addition, subsequent screens such as “On Screen Guide,” “Video on Demand,” “Pay Per View,” etc. may need to be sent to the remote. If the N, or “No” decision is the output of step 812, then the host may perform other appropriate action.

A few concrete examples of the previous steps may be instructive.

Assume that the user has just installed the Modular A/V system and is using it for the first time. Upon powering up the host, the host will perform its internal inventory to determine what hardware and software modules are loaded. After completing this initialization process, the host begins broadcasting to find a remote. The remote will display the Startup screen until the remote and the host establish communication. Once communication is established, the host will send the “Home” screen to the remote.

The Home screen lists options for the user to select from, such as “Watch,” “Listen,” “Record,” “Move Data,” “Goodies” and “Setup.” These particular options are available on all models of A/V apparatus. Based on the included modules recognized by the inventory at startup, some options underneath these headings may not be available. For example, “Watch Cable” would not be available under the “Watch” function if the cable module is not installed in the device.

In addition to sending the “Home” display to the remote on startup, the host would also send the screens for any option that the user could select. In this case, the host sends six additional screens, one for each of the six functions supported: Watch, Listen, Record, Move Data, Goodies, and Setup.

The user selects “Watch” from the Home screen. The “Watch” screen on the remote loads quickly because it is already stored locally on the remote. This user selection is sent back to the host, which prepares the subsequent screens to be displayed based on the user selection.

A multiplicity of sources are supported by the host. An individual device may include any or all of the following: DVD player; Cable; Tuner; Internal Hard Drive; external analog source; external digital source, (such as a camcorder connected to a Firewire input.); and so on.

For this example, assume that this host has a DVD player, an internal hard drive, and an analog tuner. Thus, the host must prepare and send three subsequent screens to the “Watch” when the user makes his selection: one for the DVD player, one for the internal hard drive, and one for the tuner. The subsequent screen for each device is different. The DVD player has selections like Play, Pause, Fast Forward, Rewind, etc. The subsequent screen for the internal hard drive would display a file system so that the user can select a file to play back—and it would have its own subsequent screen similar or identical to the DVD screen, with the Play, Pause, Fast Forward, Rewind, etc. selections. The subsequent screen for the tuner is a keypad, with functions like Channel Up/Down, Favorites, Last, etc.

The host sends only the installed options to the remote for the user to select from—the other functions that the host supports but are not installed are not made available as options to the user. Because there is no Cable module installed in the example host, the user will not see any selections involving the Cable module.

In this example, the user selects the Tuner function. The keypad function is already loaded on the remote and so displays quickly. The remote communicates this selection to the host. In this case, the appropriate action for the host is to switch the tuner signals onto the Audio In and Video In bus. If the tuner is set to a channel that is broadcasting, this signal will be sent to the speakers and monitor. Since there is no subsequent screen to the keypad, the host does not need to send a subsequent screen to the keypad.

The user can now use the keypad to choose the channel to be watched.

As can be seen in the foregoing example, it is necessary for the host to know the software and hardware modules that are contained internally so that the remote displays the proper information. It is also necessary for the host to know the information that is currently displayed on the remote so that the host correctly interprets the response from the user and prepares the appropriate subsequent screen.

To continue the example, the user watches TV for a period of time. During this time, the remote has gone into a power saving sleep mode. The user desires to change the channel, and so activates the remote by touching the screen or a power button. The remote would still display the keypad, since that is the screen that was displayed when it went to sleep. The host needs to ascertain the display that is on the remote in order to properly respond to the user input. If the host does not confirm what is displayed on the remote, one can envision a situation where pressing a function on the remote causes the host to behave in an unexpected manner. As an example, if the number “3” is displayed on the remote and the “DVD play” button is in that same location in the screen that the host believes to be displayed, pressing the number “3” will cause the DVD to play.

A second embodiment of the remote control can be simplified even further. Rather than have the remote be used as the display device (LCD touch screen) the remote is simply a wireless mouse or other pointer device, and the host sends the information on the Video Out bus. The user navigates the screen with the mouse-like remote. The TV screen would be divided into functions that the user could select. When the pointer is over a selection, that selection would highlight, and pressing enter on the mouse-like device would select that option. This remote to host communication could also be performed using Bluetooth or other wireless technology. Note that in cases where there is already content on the screen, such as watching a movie, broadcast television, or cable, the screen can be reduced in size with the commands located along the top, bottom, or an edge; or the commands can be transparent overlays.

The described embodiment of the host interface for the remote control is a modular home entertainment center. However, the host can be a standalone box that has the ability to control existing home entertainment equipment through an IR transmitter/emitter or other suitable wireless technology, thus forming a system. This standalone host can perform similarly to the modular host, by having the IR codes to control these devices programmed into it. The standalone host would be programmed with the manufacturer and model of each piece of equipment to be controlled. Thus the standalone host would know the combined features of all equipment being controlled, and would be able to work in a coordinated manner to perform the desired function in the same manner as the modular A/V assembly host. For example, if the user selected a DVD as the source device, the host would perform the following functions: turn on the DVD player; turn on the audio amplifier and set the audio amplifier source to DVD; turn on the television monitor and set the monitor source to progressive input. This concept will be explained in more detail in the “Controlling Third Party Hardware” section.

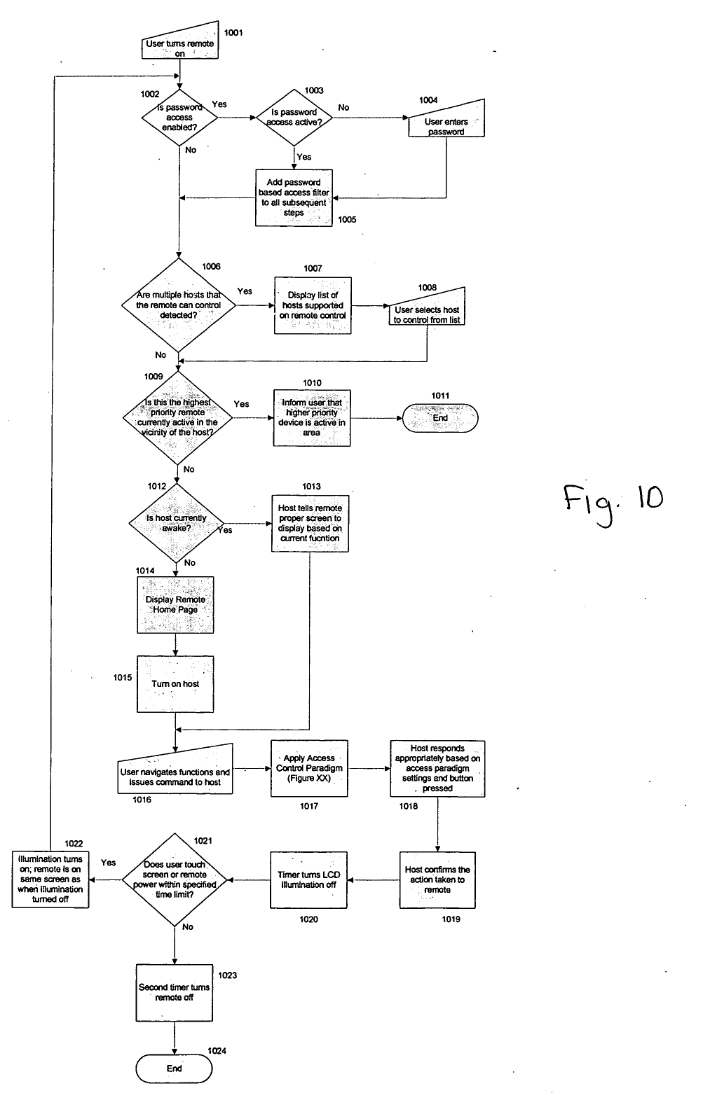

FIG. 8 is describes a simple situation with no complicating factors such as multiple remote controls, multiple hosts, parental controls, or other complicating features present. FIG. 10 adds these features.

As can be seen by the flowchart, the remote can be simply a display and input device for the host. Alternately, it can contain substantial intelligence, depending on the needs of the system

In step 1001, the user turns the remote on, causing it to begin broadcasting a signal to hosts in the area. Multiple host control is discussed in the “Access Controls” section; suffice it to say that by the end of either decision point from Step 1002 the user has identified all hosts in the area that he is capable of controlling and determined which available host device that he wants to control.

In Step 1005, the host determines if that remote has priority over other remotes in the area to control the device. Again covered in Access Control, this prevents conflicts between remote controls by determining a sequential priority for all remotes that can control a host.

Is Step 1008, it is determined if the host is awake. If the host is not awake, then the remote and device are automatically synced up on the home page (1010). If the host is awake, the remote must display the correct display based on the host's current state. For example, if watching a DVD, the remote should be sent to the DVD control page upon waking up.

By Step 1012, the host and remote are both awake and in sync. The user issues a series of commands. At step 1013, the access control paradigm, such as Parental Controls, is applied. The host responds appropriately based on the user's ability to access the requested functions. In Step 1015, the host confirms the action taken to the remote, including confirming that the remote is displaying the correct page, based on the command issued.

After a period of non-use, the remote's illumination source will turn off to conserve battery life. Issuing a command to the remote by pressing a button or touching the screen during this time period will return the remote to step 1002. Eventually, the remote will turn itself fully off.

General Host Interface Interaction with Remote Control Device in Other Applications

The remote control is described here as being used principally to control an A/V entertainment center and the interface to the remote control is set forth as part of that entertainment center. However, the remote control can be used for other functions within the household and in commercial application. One household example is for use with one's home security system. In this example, the security system has a transmitter attached to the control panel. This transmitter broadcasts a signal to the remote control, indicating that it is present. When the user wants to access the security system, he or she presses its icon on the remote control's touchscreen, displaying the security system control panel. This control panel display may have the following icons: a 10 key pad, “ARM, “DISARM” “ENTER,” “PANIC” etc. If the house is not secure, this information may be sent to the remote. For example, the alarm would not set, and the remote would display “Kitchen Window Open” or “Motion in Hallway.” The remote also can display the status within the house. For example:
1:13:03 AM Rear Door Open
1:13:20 AM Correct alarm code entered at rear keypad
1:13:37 AM Motion In Living Room
1:13:52 AM NO motion in Living Room
1:14:01 AM Motion in Stairwell to 2nd Floor
1:14:28 AM Motion in Upstairs Hallway
   This offers the opportunity to track the status within the house in real time-useful in case of a break-in or in surveillance.

Additional applications would be to control household appliances and other household items using the processes above. That is, instead of having the remote control interface in a modular audio/video assembly entertainment center as described above, it would be in a control panel or other appropriate control apparatus implementation and would use the same process to transmit control information as explained above with respect to an entertainment center or modular audio/video assembly. Examples of additional applications would be to control the following household matters:
Sprinklers;
Washer/Dryer;
Dishwasher;
warming up a Spa/Hot tub;
turn on the heat, the pump, the sweep, retract the cover of a swimming pool;
house fan;
control lighting, both internal and external;
turn on the speakers for external or multiple speakers in the home or in the backyard;
control the volume for the above speakers;
Fish feeder control;
turning on and off the Coffee maker setting and turning off the Alarm clock
turning on and controlling personal computers;
turn off or on Water features such as fountains and the like
Alarm systems
Gas Grill
Gas Fireplace
Thermostat
Similarly, this remote control interface can be used as part of a wireless WAN or LAN and then perform all of the above control functions over the Internet.

Below are additional examples of some of the above home devices to be controlled by this remote, as well as examples for commercial applications. In these examples, a transmitter that knows the features contained within its host controls the displays that are shown on the remote as was described for the modular A/V assembly above. Some of these devices are sophisticated to use, such as:

Sprinklers. In this case there can again be an existing control panel that can be easily mapped to the remote control display. A sprinkler has multiple zones that turn on and off at specified times. Thus, when the remote functions as sprinkler control, as an example of the first option the user would select is zone. Then a daily or weekly calendar for that zone would appear, as explained for sending subsequent screens in the modular A/V assembly case, and the user can specify on times and off times for each zone.

Pool. The pool has a number of features that can be controlled. These include timing of the main filter pump and pool sweep, controlling the water temperature, retracting the cover, etc. These functions can be controlled by the remote control in real time or pre-set, individually, or grouped together. For example, upon activation of the remote, the user may have three options to choose from: “Control Pool Now”; “Daily Pool Functions” “Pool Party”,

In the first case, “Control Pool Now”, for example, the user could turn the filter pump and pool on sweep for a specified or indefinite length of time using the remote. Furthermore, the controller can have the intelligence to know that the sweep must only be turned on fifteen minutes after the main filter, and be turned off fifteen minutes before the main filter to prevent burning the motor out.

In the second case, “Daily Pool Functions” the user can specify the filter to run daily from 9 AM-11 AM daily using the remote in a manner similar to that outlined for the sprinklers.

In the third case, “Pool Party” the user would use the remote to specify the time of the pool party, such as Saturday from 2 PM to 8 PM, as well as the desired pool temperature. The pool controller would complete a series of actions, such as:
turning on an electric or solar heater to increase the water temperature to the desired state in time for the pool party;
checking pool chemical levels to ensure that it is in a safe operating range;
running the filter and sweep for a specified period of time to ensure that the pool is clean prior to the party;
retracting the pool cover at the specified time to conserve heat and maintain cleanliness;
turning off the heat and running the filter after the party has concluded;
again checking pool chemical levels after the party and adjusting as necessary.

Thermostat. The remote can be used to control a thermostat. The user can base this control on day, time, temperature, or other factors. For example, the remote can set a Monday through Friday temperature control sequence and a separate control sequence for weekends, when the house is occupied all day. The user could set the whole house fan to turn on when the internal temperature exceeds the external temperature by a specified amount, and leave the fan on until the house reaches a desired temperature. The remote could be used to set different temperatures in different rooms or area of the house. For example, the upstairs sleeping quarters may be warmer at night than the downstairs living area.

External Speakers. The remote may be used to turn on external speakers and adjust their volume.

Lights (internal and external). The remote may be used to control internal and external home or other building lights. It may turn lights on or off, act as a dimmer, or change settings of external lights from each function to another. These external lights are typically tri-state: Always on, dawn to dusk, and motion detecting.

Spa. These features are similar to the pool outlined above. The user can specify water temperature, the timer, control which jets are active and the like.

Gas Grill. The user could turn on the gas grill remotely at a specified time, and set the internal temperature. Gas pressure could be monitored, informing the user if gas is running low. The grill could be set to turn off at a specified time. In a similar way, a gas fireplace could be controlled. Both of these devices would have automated feedback loops to ensure that a safety hazard is not created. For example, if a heat source is not detected, then the gas would be turned off to prevent a potentially explosive buildup of gas.

Personal Computer. The remote could be used to control a PC also. This would be useful in a wired home, where the PC is a central server for home entertainment functions. The remote can be used to turn the PC on or off, as well as activate and control its various functions: browse the web, stream a stored video file to a monitor anywhere in the house using a wireless LAN; or perform other functions that the PC supports anywhere in the house.

The remote can be used to set timers on simple devices such as coffee makers, alarm clocks, pet feeders curtains, blinds, or shutters so that they open or close at specified times of the day, or the user can control them manually using the remote control.

Oven. The remote control can control the oven to preheat it to desired temperature, or send the oven into a self cleaning mode. Similarly, it can be used to control a microwave. For example, the microwave could be set to go through a certain cycle to defrost and then cook a dish.

There are also other devices that the remote can control, such as washers/dryers, dishwashers and air conditioner. Since the user is required to be next to these devices prior to use, it may initially appear that there is no problem to be solved by a remote. However, these devices are often noisy, and it may not be desirable to leave them running when outside the home. Thus, the remote can be used to turn such devices off when leaving the house, or turn them on when going to bed. Furthermore, the remote can be used to notify the user that these devices have completed their cycles. The remote can also notify the user of the device's status-if the washer has been run and the door not opened, the remote would remind the user that there is a wet load of laundry in it.

The remote can be used to control a series of devices. For example, assume that it is nighttime, and the user has just gotten into bed. The user sets the alarm for 6 AM and presses the “BEDTIME” button. The remote then performs the following functions: turns on appropriate exterior lights; turns off appropriate interior lights; turns on the dryer and dishwasher; and sets the alarm. In the morning, the lights turn on and increase in brightness gradually prior to the alarm time so that the lights are fully on at the specified wakeup time. Similarly, the radio is turned on at a low volume at the same time as lights turn on, gradually increasing the volume until it is at normal volume at the specified wakeup time. This gradual increasing of the light and gradual raising of volume will ease the user out of slumber, rather than jarring the user. Or the house lights may come on, as programmed. The coffee maker has already been programmed to have coffee ready at the same time as the alarm is set for. The external lights can be turned off at a specified time.

This remote can also be used to establish a pattern for leaving the house for the day, ensuring that all lights are turned off, the security system set, and all major appliances turned off, if desired.

In the event that the house will not be occupied for a period of time, such as a vacation, the remote can be used to set a sequence that the lights, radios, televisions, and other controlled devices can run. As part of the vacation routine, the time at which these events occur may be variable, based on user settings. This variability may draw less attention than if certain lights always turn on at exactly 5 PM.

The above descriptions detail ways that the remote can be used to control devices in homes. The remote can also be used to query or control devices in industrial applications. For example, the remote can be used in a concert venue to control lighting and sound. In this application, the sound board and light board are the two host devices. The user can sit anywhere in the theater-a balcony, front row, back row, etc. and adjust the lighting and sound using the remote.

The remote can also be used to control and monitor production equipment. For example, in a chemical plant, the host can be attached to processing vats. The host would transmit data concerning inflow and outflow rates, internal temperature and pressure, etc. The user could adjust these parameters if desired using the remote.

Similarly, the remote could be used in a plastic injection molding factory. Individual machines would have hosts, who would transfer data such as cycle time, pressure, temperatures at different locations, lot size, estimated completion time, etc. The user can adjust parameters as necessary—for example, change the heating parameters to compensate for a heater band having failed.

Other plant machinery would have hosts that transmit screens or other information to the remote control allowing it to control speed up, slow down, perform a certain number of operations before turning off, or controlled in other ways. In addition, warning conditions, such as overheating, running out of raw material, or running out of available space may also be sent to the remote control.

Traffic. A host associated with one or multiple lights could transmit screens or other information to a remote control to allow traffic engineers to adjust the timing of stoplights in real time to improve traffic flow. The remote can be used to adjust the timing of each individual light. Based on the screens or other information the host transmits to the remote control, the engineer can tweak the signal, observe the changes in traffic flow, and then adjust quickly. Multiple lights can be controlled via a repeater or WAN system allowing one a multiplicity of hosts to transmit screens or other information to one or more remote controls so that changes can be made to a large area simultaneously. In this case, the remote would display a listing sent by the host(s) for each light. The engineer would select a particular light to change and make the modifications. For example, making changes to the light at the intersection of 13^{th} and J St may cause traffic to back up two blocks way, on 15^{th} street. The timing of the lights at 15^{th} street may then be adjusted. The host may even be removable to prevent tampering with the light timing.

Detailed Description of the Remote Control Device

The remote can be implemented to have several properties not seen in traditional remotes such as, for example:

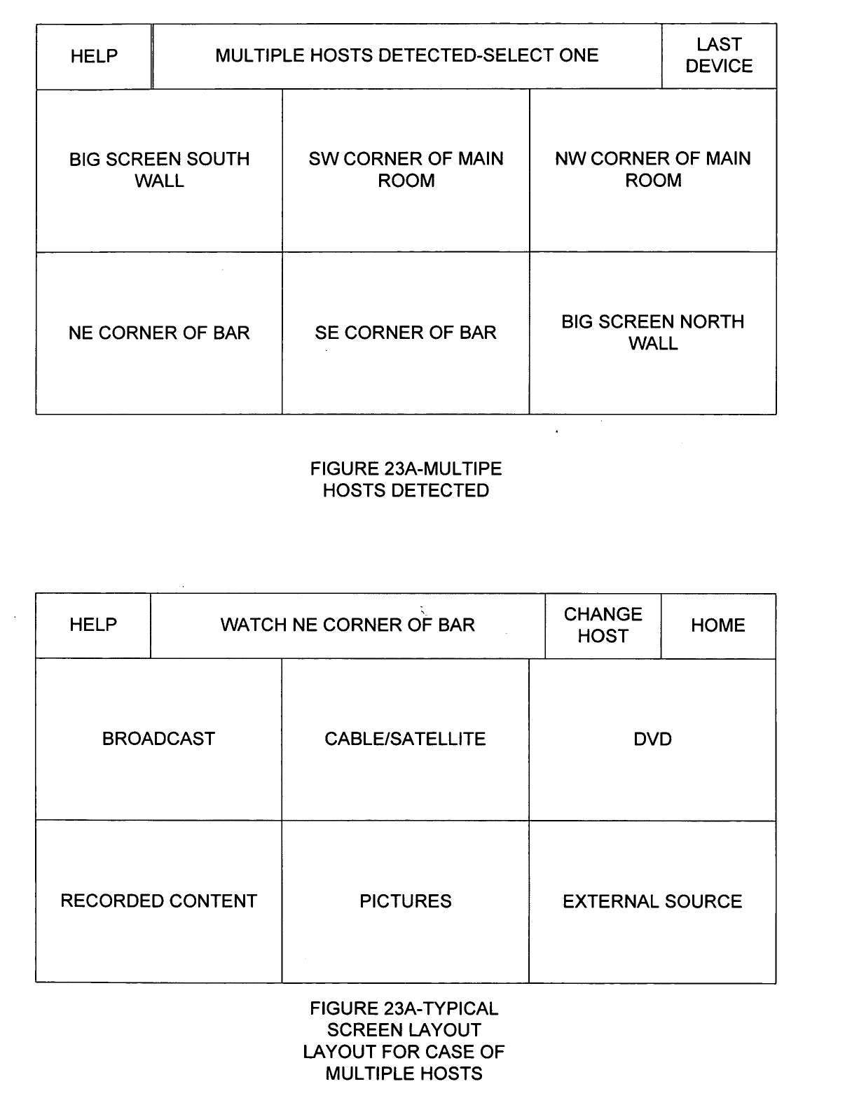

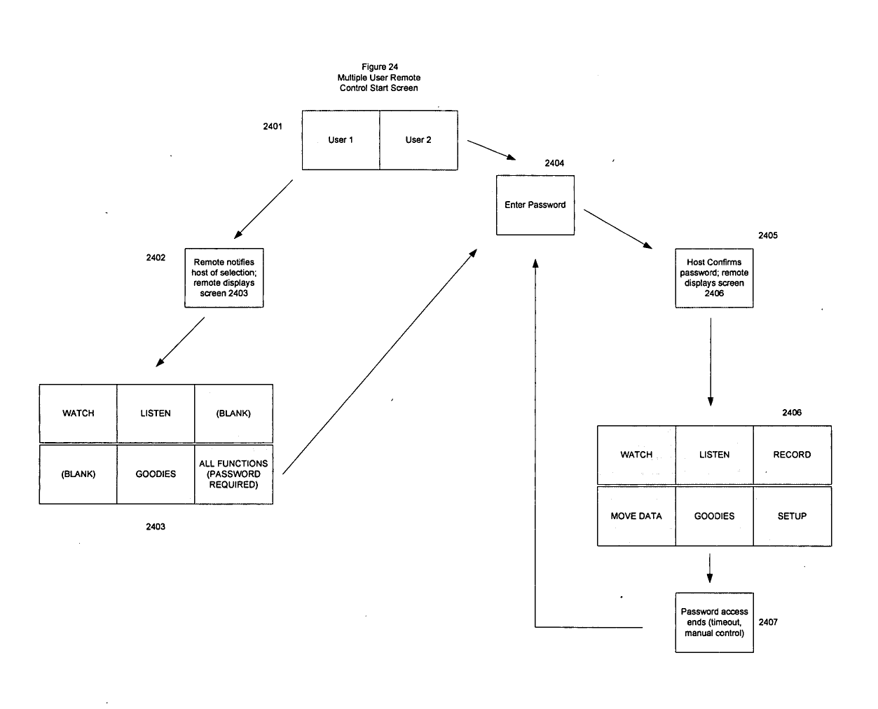

1. The face of the remote control device can be arranged by logical function, rather than by device. Logical functions include “Watch”, “Listen,” and “Record.” If one wants to watch a recorded program, live TV, a DVD, or a slideshow, one selects the “Watch” function. If one wants to listen to the radio, a CD, or MP3 files, one selects the “Listen” function. If one wants to record a TV or radio show, one selects the “Record” function. While this paradigm is naturally supported by the modular A/V architecture described herein, it also extends to third party devices that come under control of the remote and host a/V apparatus. For example, a third party DVD player would be listed as a device under “Watch” logical function rather than as a separate, standalone device. That is, the remote control device can control any device of a plurality of controlled devices by controlling the functions of each device. Therefore the controlled functions for a controlled device are arranged on the display of the remote control as the controlled device is being controlled. As another controllable device comes under control by the same remote, the functions of that controlled device can be displayed on the remote for the user to use in the control function. The result is a remote control device arranged to control many devices and device types, instead of requiring a remote control for each of a number of controlled devices. The manner in which this capability is learned and used is detailed by FIGS. 23-26.

2. The remote need recognize and display only those functions that are available in the host. For example, if the host is an A/V system, it might be that it does not include a DVD burner. The remote need then not display any DVD burner functions.

3. The remote can support upgrades to the controllable system indefinitely, limited only by available memory in the remotes. Thus, the remote is not obsoleted as new features are added to the host.

4. The remote can be implemented to include the processing power to interpret and display the compact language that it communicates in, but it need not necessarily “know” what those commands mean. For example, the remote may send only X,Y pick locations for the host to interpret, or the remote may send function specific information such as “Function D4” was selected, with “Function D4” having a specific meaning to the host.

5. The remote can control more than one host. For example, one could bring a remote control from the living room, where it is controlling the living room A/V system, to the bedroom. When the remote comes in range of the bedroom A/V system, it will recognize the bedroom A/V system and display the features and applications that the bedroom system supports.

6. The remote control can be implemented to support multiple types of hosts. For example, the remote control may detect a home entertainment device, an illumination controller device, and a security system device. The user will need to select which host he or she wants to control with this remote. The identification of these hosts by the remote can be made in a number of ways. One way to accomplish this is to have the host send a bitstream to the remote that identifies the host by function (dishwasher controller) or by class (Home Appliance, A/V equipment, Illumination, etc.). The remote control need not have the knowledge of what these host devices are. The remote can be as simple as a display and feedback device, displaying control information sent by the host and sending feedback to the host as to what functions to select or control.

7. The remote can control more than just A/V equipment. For example, the lighting in a room, the thermostat, or other electronic devices could be controlled by this remote. Lights may dim automatically when a user is watching TV to reduce glare and enhance contrast.

8. The remote can display pertinent information about the state of the host. For example, Television channel numbers and call signs, radio station names and numbers, show names, song titles, movie titles and lengths, and other relevant information can be displayed on the remote control.

The user then has an indication of one set of a possible plurality of sets of control screens for the host's components reconfigured on the remote's touch screen, or other input device, and operates the screens to input control data to the host as at 810.

There are several alternate embodiments. Any function performed on the remote could be duplicated with a mouse or other pointing device and the TV monitor. Another option would be to fix the number of display screens at each level. Rather than using a touchscreen, there could be a button associated with each of the display screens. The user would push the button associated with the display screen. This takes advantage of is the flexibility of the display without requiring the expense of a touchscreen. Yet another option would be blends of the approaches listed above. For example, there would be six buttons on the remote associated with the six core functions-Watch, Listen, Record, Move Data, Goodies, and Setup. The user would press a button on the remote, and options for that function would appear on the monitor screen for the user to select from.

Actual screen organization will be discussed in additional detail subsequently.

The bi-directional, or push-pull, remote control can use two-way communication between the remote control and host, using an efficient graphics language such as HTML as the communication protocol. Further, the remote need display only functions that are available to the host. In one preferred embodiment, the functions available on the controlled system, such as a home entertainment center, will be transmitted to the remote control upon communication between the remote control and the host. Thus, if the host does not have a particular function available, such as burning DVDs, the host will not transmit an indication of that function to the remote and the remote will not transmit information to control this function.

The remote is upgradeable, based on the features available in the host. That is, as the host, such as a home entertainment center, is upgraded, it will recognize the new, upgraded features as explained with respect to FIG. 8, and will transmit screens for them to the remote control which will then be able to select them. A variant would be to have these unsupported features greyed out or otherwise indicated that they are not installed.

There are features in the host that are needed for operation of the remote control. This includes the host's knowledge of available functions and features (both hardware and software) of the host; organizing those functions and features into a display in a logical fashion; and broadcasting that display information to the remote in a compact language such as HTML. Alternatively, this organizing of functions and features into a display in a logical fashion could be done in the remote itself in well known ways if sufficient processing capability is in the remote.

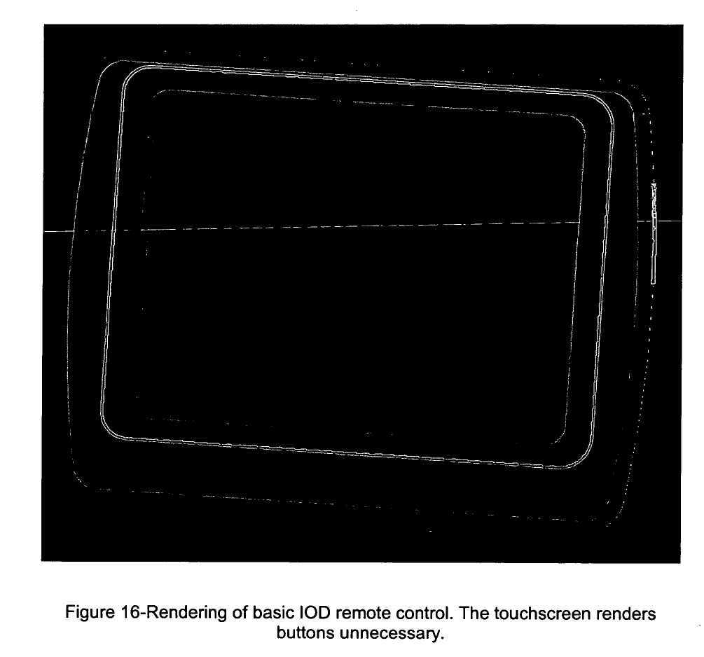

The remote itself is seen in the rendering of FIG. 16. It comprises a touch screen, making buttons unnecessary. The implementer could, however, use buttons if this were desirable. The actual screens that appear on the screen of FIG. 16 will be described with respect to subsequent figures. It can be implemented such that any time the remote is powered on, it will broadcast to and communicate with any host within range by well known means such as Bluetooth. Thus, the remote is not tied to a specific host or a specific type of host.

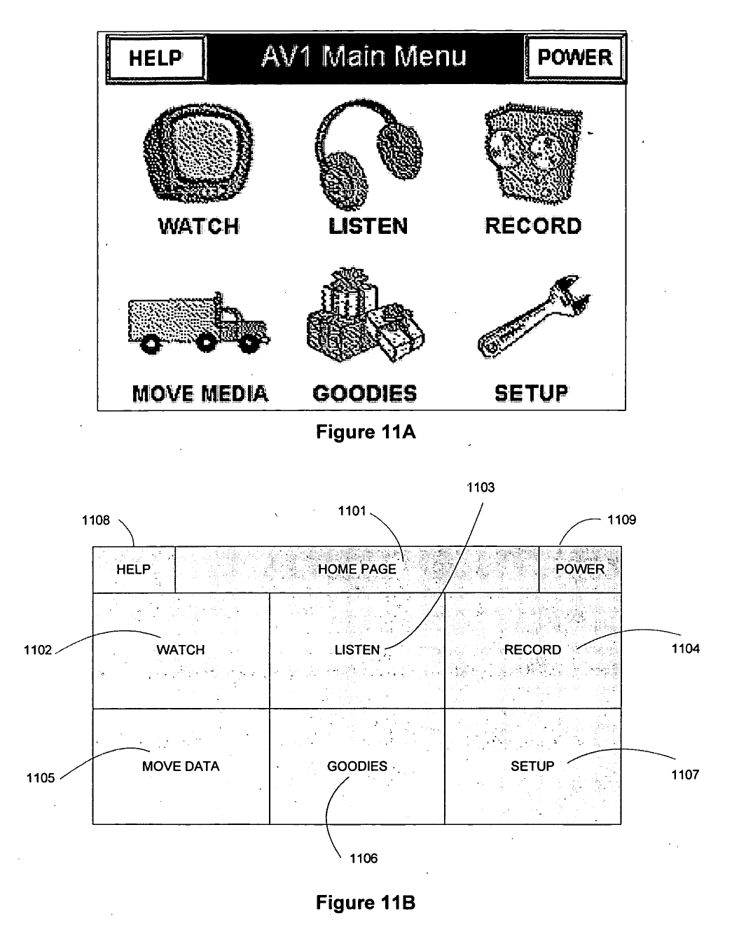

FIGS. 11 through 14 are a representation of the Home screen and subsequent screens for the remote control.

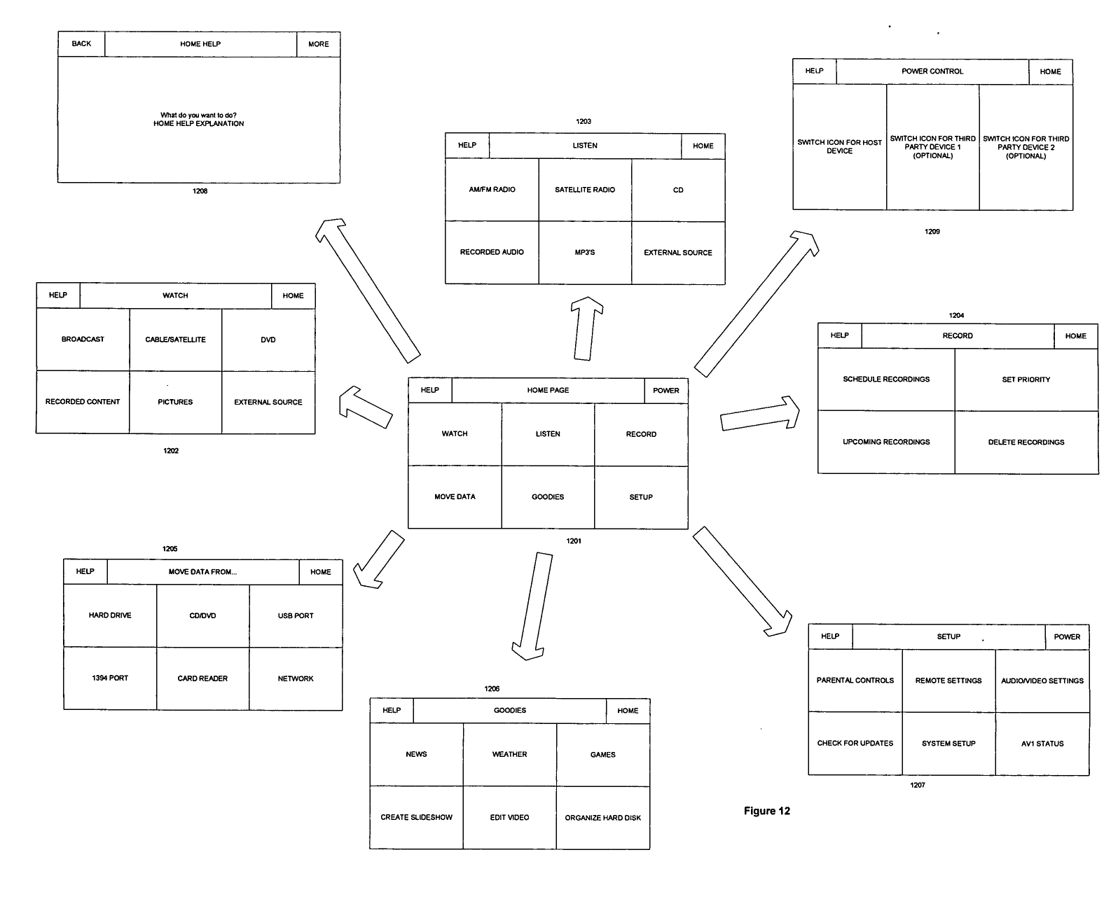

There are several relevant features to note in these Figures:
a. The remote and the host can be designed such that at the time that the Home screen sent from the host is loaded into the remote control's memory, the host, since it knows all its internal components, sends to the remote all screens that could appear if the user were to select them. That is, information specifying all the functions available for controlling all components installed within the host can be sent to the remote control and loaded also. This allows the remote display to be updated quickly, without waiting for additional data from the host device. This is shown as the “YES” decision leg on Step 804.
b. Some features are common to many screens. These common features are consistently located. The following are examples of such common features:
   i. A “HOME” touch location that will display the “HOME” screen when selected. For obvious reasons, this is not necessary on the “HOME” screen.
   ii. A “BACK” touch location to take the user to the previous screen. The “Home” touch location can serve as the “BACK” touch location for the Function screens, as shown in FIG. 11.
   iii. A “DESCRIPTION” location that briefly describes the current screen function. For example, “HOME” on the home screen and “Watch” on the watch screen of FIG. 12, or “Play DVD” on the DVD page of FIG. 13.
   iv. For the case in which the host is a home entertainment system, common Home entertainment functions such as “Power”, “Favorites”, “Volume up/down”, “Mute”, “Channel up/down”, and “Previous Channel” may also be in all screens. These are not shown in the block diagram for simplification.

These elements are demonstrated in the corresponding Figure, as detailed below:

FIG. 11A is an actual bitmap image of the remote control as it would appear to the user. The logical function of the options available becomes readily apparent. The user has six options to choose from in this example:
a. “Watch,” allowing the user to send any available host video source component to the viewing monitor;
b. “Listen,” allowing the user to send any available host audio source content to the speakers.
c. “Record,” allowing the user to record content from any legally available host source component, either audio or video;
d. “Move Data,” allowing the user to move or copy data from one location to another, including burning DVDs or CDs;
e. “Goodies,” allowing the user access to such functions as games, sports, weather, video editing, etc.
f. “Setup,” allowing the user to control settings such as parental controls, remote control settings, installation of software updates, etc.

The user just has to ask himself, “What do I want to do?” and select the answer from the list provided: “Watch;” “Listen;” “Record;” “Move Media;” “Goodies;” and “Setup.” Notice that the list of options can be represented by both words and icons. For example, at TV set is associated with “Watch;” earphones with “Listen;” a tape recorder with “Record”; a truck with “Move Media”; presents with “Goodies” and a wrench with “Setup.” Similar icons can be used throughout the system.

FIG. 11B is a simplified representation of FIG. 11A. In it, several of the design elements discussed above can be demonstrated.

In the top center (1101) is an identifier for the page that the user is on. This informs the user of their location in the system. This are is not active; pressing it has no function.

The areas identified as 1102-1107 are the active area of the display, from which commands are issued. In this case, the user has six options. Each of these options has additional screens that become visible when one of the options is pressed, as shown in FIG. 12. This arrangement reduces clutter and provides clear navigation to the user.

Areas 1108 and 1109 are used to provide additional tools the user. These areas are active. In the Home screen, shown in FIG. 11, Area 1108 is a Help button, providing aide in navigating the remote control. Area 1109 is a power button, allowing the host device to be turned off. The host is automatically turned on whenever an active remote is detected in its vicinity. Any third part devices controlled by the remote would also be powered on or off through this location.

The power icons can be switches that the user “flips” up or down. Sliders, buttons, and other well understood touchscreen input methods can also be implemented. An audible feedback can also used when a button is pressed.

Areas 1108 and 1109 will have other functions in other screens, as will be shown later. Area 1109 is universally used as a “Home” button (except on the Home page), bringing the user to the home page. In many screens, Area 1108 is a “Back” button, taking the user to the previous page.

FIG. 12 shows the Home page in the center of the various screens that can be displayed in response to a specified input. For example, pressing the “Watch” screen will cause the “Watch” page, Item 1202, to appear on the touchscreen. Notice that the upper left hand corner of the “Watch” screen is still a “Help” button, while the upper right corner is now a “Home” button. Having a “Back” button in the upper left corner would be redundant, since it would return the user to the Home screen.

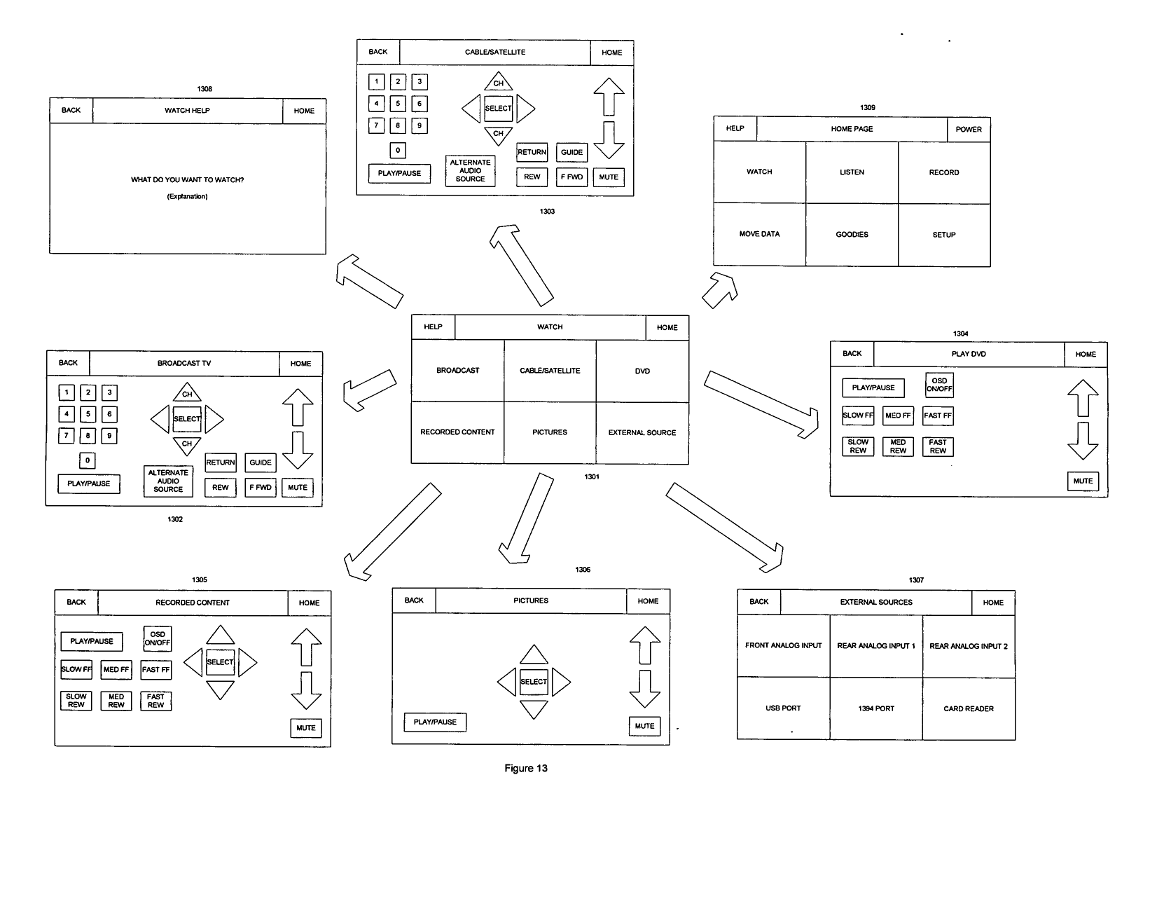

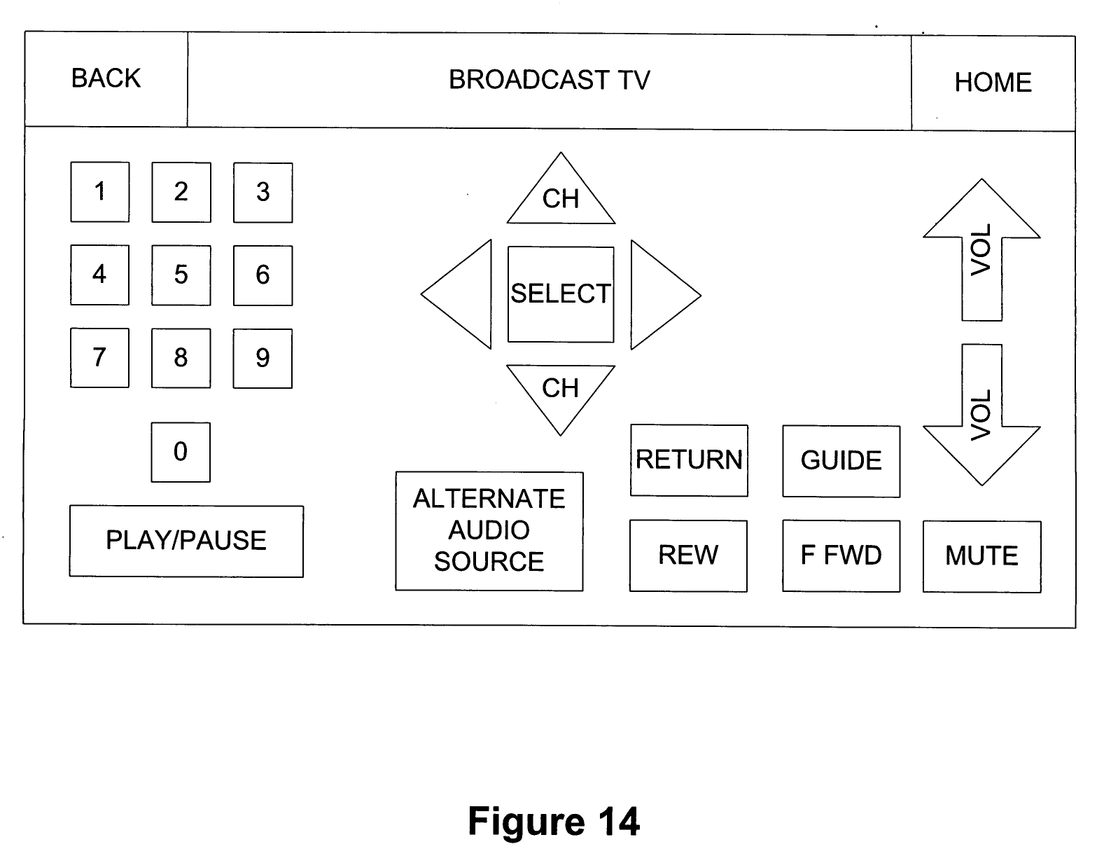

FIG. 13 shows the results if one presses one of the options from the “Watch” screen, while FIG. 14 shows details of the “Broadcast TV” option. These two figures give additional detail as to the nature of the devices and functions supported by the host.

Referring back to FIG. 8, we can give a concrete example of the “No” leg of FIG. 805. This leg is entered when it is determined that the entire architecture of the displays should not be sent to the remote due to memory or time constraints.

Initially, the remote would send the Home page, 1101, to the remote. Immediately after that it would send the eight subsequent screens to the remote (Items 1102-1109). Assuming that the user selected “Watch”, the remote would display the “Watch” screen, Item 1102 or 1201, from its internally stored memory and inform the host of the command selected. The host would then send the subsequent screens available from the “Watch” page, Items 1202-1208, to the remote. Note that the home screen, Item 1209, is already stored on the remote. If the user selected the “Broadcast TV” option then the screen shown in FIG. 1302 would appear on the display. Since there are no screens accessible from this screen going down the hierarchy, the host does not have any subsequent screens to load. Its only job is to execute the command issued, such as changing a channel.

As further examples of operation, pressing the “Back” button from FIG. 14 would change the screen to Configuration 1301; pressing the “Home” button from anywhere would change the configuration to that of FIG. 11A.

FIG. 14 contains common TV functions, such a numeric keypad, channel and volume up/down buttons, and a mute button. It also has features common to a Digital Video Recorder: Play/Pause; Rewind” Fast Forward. The guide is a database of available content based on the channels that are available. This guide can be downloaded over a network connection and contain up to two weeks of data.

The alternate audio source is a novel aspect of this device and was previously disclosed.

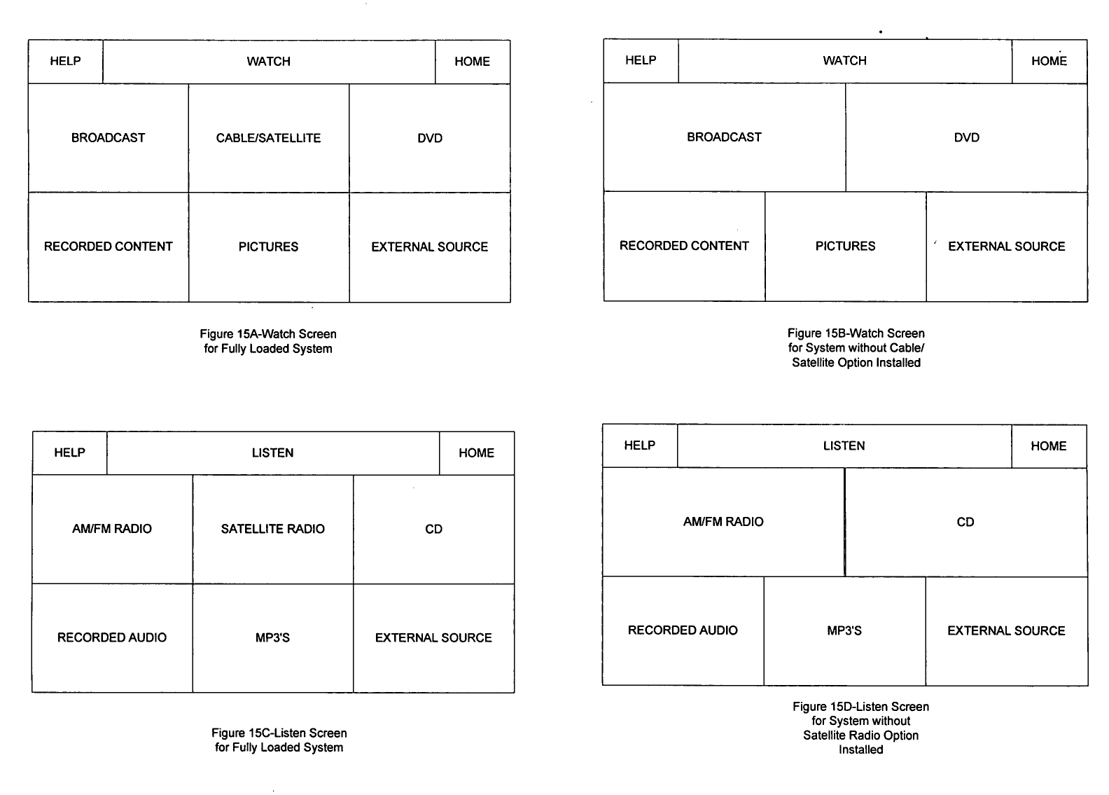

As shown in FIG. 15, the number of user selectable screens can change. In this example, the selection options are based on internally installed components. Other causes in the variation of displayed screens will be detailed later.

FIG. 15 demonstrates how the modularity of the device interacts with the remote control display. In FIG. 15A, the “watch” screen is completed for a fully loaded system. The user has it connected to both an antenna and is using the cable function. Thus, all options are available. A second system may not have the cable option installed. Its “Watch” screen is shown in FIG. 15B. Notice that the “Cable/Satellite function is missing. This can occur because of the inventory that the host does at Step 801, wherein it identifies its modules and components. This ensures that the user only has access to functions that the host supports and is not confused or distracted by buttons for functions that the host does not support. This feature can also be used as part of the Access Control Paradigm. Young users of the device may be presented with only “Watch” and “Listen” options, for example. This will be detailed later in the document.

Rather than removing the functions completely from the screen, alternative embodiments can be used. For example, an icon may be “greyed out” to indicate that the device can support this function. The button would be inactive, or present the text “This not feature not supported in this host” when pressed.

Similarly, as shown in FIGS. 15C and 15D, the “Satellite Radio” option shown in 1203 would not be visible if the user did not purchase this option.

In order for the host and the remote control to act in the manner described above, the following should occur:
a. The host identifies its modules and the functions that those modules support. The highest level of this information can be displayed in the Home screen of the remote control, which is always accessible to the user.
b. After the user makes a selection, the remote will display the appropriate screen for that selection, since it was stored in the remote's memory to display quickly. The remote will then communicate the user selection to the host.
c. Based on the user's selection, the host can determine what information to display for each option available to the user. The host must determine the relevant information for these screens based on the modules that are available and the functions that can be performed by a particular module. For example, if the user wants to watch recorded content, a numeric keypad need not be displayed on the remote.
d. The host must format the relevant information for the multiple display screens in a logical manner. This logical manner may take many factors into account. For example:
   i. The display should preferably be formatted in a consistent manner—for example, with a description of the function in the top center, the “BACK” button always in the same location, a universal layout for keypads, etc.
   ii. Common functions should be grouped together. For example, “Channel Up” and Channel Down” should be located near each other.
   iii. Functions that are more frequently used may take a larger display space than less frequently used ones for ease of access. A bigger icon is easier to find and thus use. The more you use it, the easier you want to be able to find it.
   e. After formatting the information, the host translates this display screen into a compact language format such as HTML for rapid transmission to the remote.
   f. The host then sends this compact display information to the remote control. This transmission can be accomplished through means that are well understood, such as BlueTooth, Zigby, or 802.11.
   g. At this point, the remote control would store the screens for any function selectable by the user in memory.

This process may occur in a loop if sufficient memory is not available to support the full screen hierarchy, or it may be done once and downloaded to the remote control as a complete menu of options.

FIG. 16 is a simple rendering of the remote control's appearance. The remote control can be a very basic mechanical device. The main mechanical components are the LCD touch screen, plastic housing, and power components, such as a battery door or charge components, if the remote has rechargeable batteries. The antenna necessary for transmitting and receiving the communication with the host can be embedded within the remote. While shown oriented horizontally in this example, the remote may ultimately be vertically oriented, depending on the ergonomics of the design.

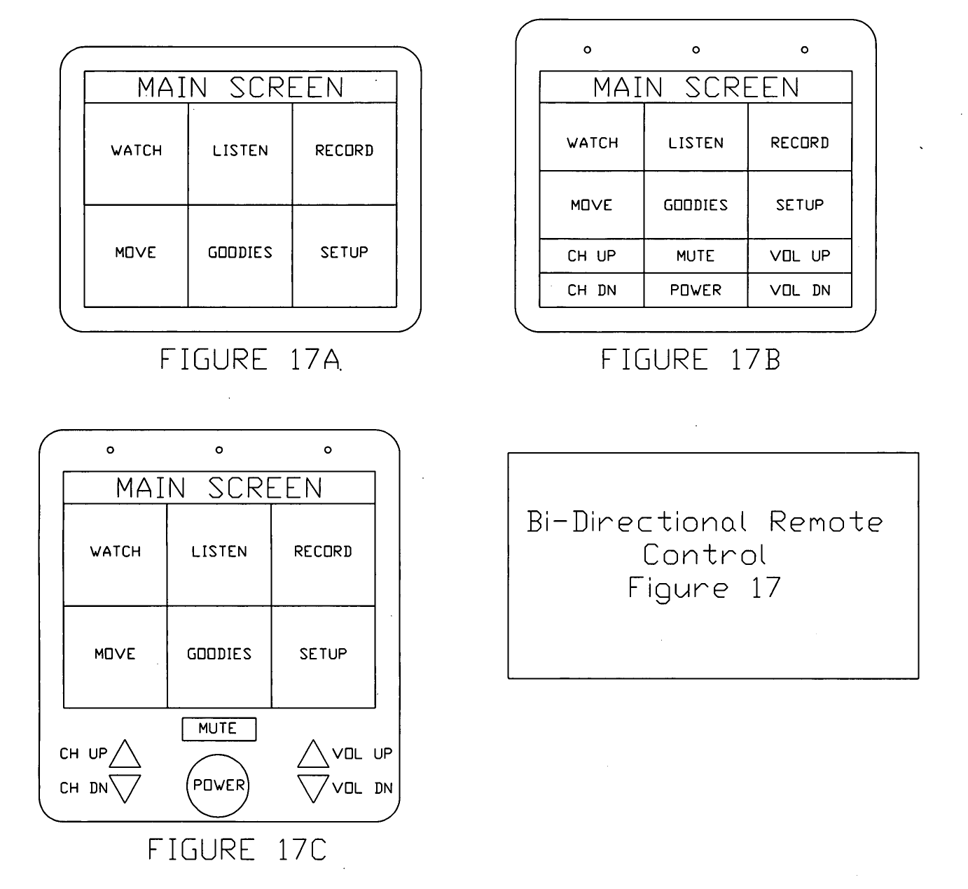

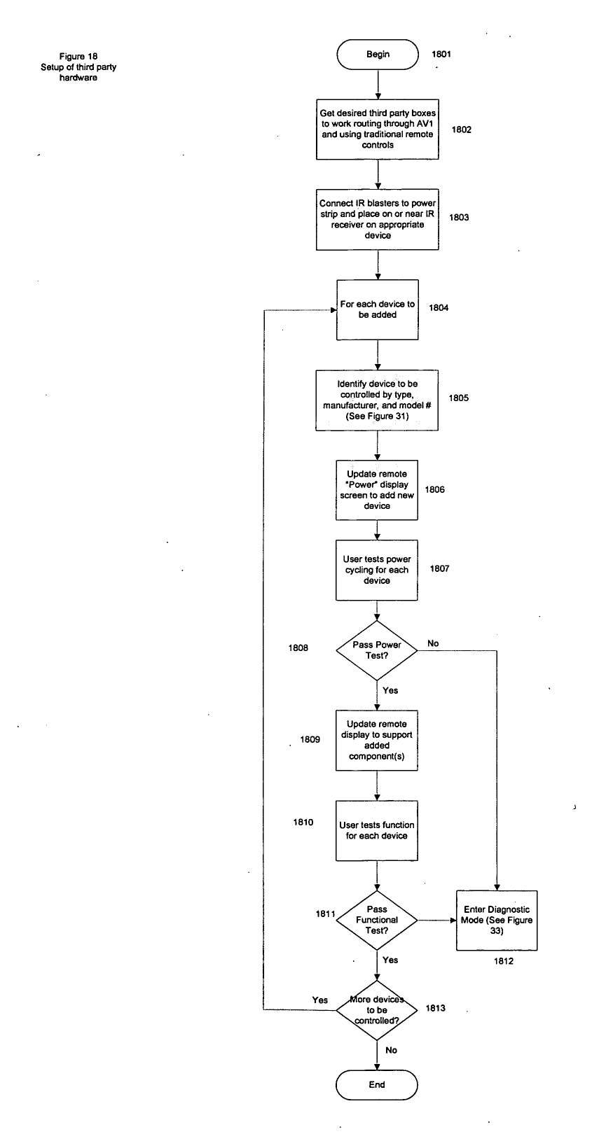

FIG. 17 shows several variations on the fundamental design. The first design shown, FIG. 17A, has the touch screen as the only interface to the user or the host. FIG. 17B has two differences from FIG. 17A, The first is the addition of common commands—channel, volume, mute, power—across the bottom of the screen. Since these commands are used so frequently, they would be available to the user in all display screens. The second addition is three LEDs (the three dots above “HOME SCREEN”) that can be used to feed data back to the user. These can be used for several purposes: to indicate power availability, that a command has been accepted, that the remote is communicating with the host, etc.

FIG. 17C dedicates traditional buttons to the commonly used functions that were introduced in FIG. 177B. An additional function that can be included is a noisemaker, such as a beeper or other appropriate sound device. This can be activated as the remote control is being used in order to give audible feedback to the user to replace the tactile feedback of a button, since the touch screen has replaced buttons. Further, the beeper can be activated by signal from the host to help the user locate the remote control when it is misplaced or lost.

The remote control can include;
Integration with a keyboard so that the user can edit filenames, browse the web, or otherwise interact with the host.
User configurability of the remote so that the user can arrange the features in the order chosen. For example, the user could always have a red “RECORD” button visible in the upper right corner of every display screen.
Rather than have the remote wake up in a “start” screen, having the remote wake up in the previous screen. The host would acknowledge that the particular display screen is still valid for that host.
Enable the host to be controlled only by particular remotes. For example, many rooms in hospitals have multiple beds, each with its own TV set. Each TV set host would have a unique remote control that interfaced with it. The host would ignore the other remote controls in the room.
Enable features based on a particular remote. For example, parents may wish to block HBO or TV-MA programming when they leave their children for the evening. The “adult” remote is then not accessible, leaving only the “family friendly” remote from their child's room to control the Home entertainment center.

Other embodiments can be as follows:
One embodiment can use an LCD touch screen and little intelligence in the remote. The remote simply sends X,Y coordinates back to the host device, which then interprets those signals and performs the appropriate action-whether to send another screen of data to the remote control, or to begin a controlled function, such as playing or recording in an A/V system.
A second embodiment is a similar remote control, but the LCD screen is only a display device, broken into sections. Each section has a nearby button associated with it. The information for which button is pushed is sent to the host, which then interprets the buttons push and performs the appropriate action.
A third embodiment would use the remote to control multiple functions or devices. For example, when the “PLAY” button is activated for a movie in an A/V system, room lights are dimmed to maximize the viewing experience. When “Pause” is chosen, the lights are brought up halfway up, and when the movie ends, they are brought to ¾ or full on. The user can specify these settings.
One embodiment of this remote uses a Bluetooth as the wireless protocol.
One embodiment of this remote uses 2.4 GHz technology.
One embodiment of this remote uses HTML as the compact language to send data from the host to the remote.
Another embodiment of this remote, for a host which is an A/V system, extends beyond the Home theater world. The remote could be used as a display device for numerous other devices. For example, it could control a PC. The remote could also be controlled by a theater marquee, enabling the user to check movie times and even purchase tickets. Rather than watch a theater marquee to display what time a certain movie is, then wait in line only to find out that it is sold out, you could select the movie you want to see from a list on the remote. Show times would be listed for that movie, along with the number of available tickets. You could order a number of seats and enter your name to have the tickets held for you at Will Call, avoiding the line.
   Controlling Third Party Hardware with the A/V Apparatus.

The A/V apparatus can be an “all in one” device for home theater. However, at a minimum, the A/V apparatus will need to connect to a display device. In addition, third party hardware such as a cable or a satellite box may need to be controlled by the A/V apparatus. Finally, the user may have a particular amplifier that they prefer to use, rather than that of the A/V apparatus. Thus, a paradigm for controlling third party devices using the simple remote control disclosed must be presented.

The control of these devices is managed through a serial connection in some cases and infrared (IR) technology in all cases. Because IR control is universally available, we will focus our efforts on that technology.

The implementation of the IR control is well understood. An “IR blaster” is connected to the host A/V apparatus. The blaster is a small IR transmitter that is placed near the IR receiver of the device to be controlled, taking the place of the handheld remote control. The IR blaster will then issue commands for the third party hardware to be controlled. The technology for these commands is well understood; libraries of these commands for individual pieces of equipment exist.

The A/V apparatus will support up to five IR blasters to control up to five pieces of equipment. Four of these blasters can be labeled with the type of device that they would control-“monitor”, “external audio amplifier”, “cable or satellite box”, “VCR”. The fifth could be unlabeled so that the user could control a different or duplicate type of device.

It is assumed that in this description, the A/V apparatus will act as a “junction box” for the home entertainment center. This means that all signals to be consumed are routed through the A/V apparatus. While this limits the configuration possibilities, it also reduces the frustrations for the end user. Another limiting assumption is that the devices connected are “modern” devices. This means that technologies such as laser disk and audio tape are not supported in a native format.

These devices can be supported, but they will not be identified by icon, manufacturer, etc.

The device types supported can be broken into three categories:

Display Devices—these are monitors or television sets. It is assumed that the A/V apparatus will be the primary source for the input to this device. Because this is the case, the user should not have to switch inputs on the display device. While the A/V apparatus will allow access to other functions, power is the only function required.

Audio Amplifiers—users may want to use an external amplifier as part of their home entertainment experience. Again, the expectation is that the A/V apparatus will be the sole source of audio, and so power will be the main function controlled by the A/V apparatus.

Audio and Video Devices—these include VCR's, cable boxes, etc. These devices are inputs to the A/V apparatus. In this case, the A/V apparatus needs to support a wide range of functions. These include VCR functions such as Play/Pause, Fast Forward, Rewind, etc., as well as and tuner functions such as Power, Channel, and Favorites. Fortunately, the list of set top box manufacturers is relatively small.

One other difficulty faced by the disclosed control paradigm is ensuring that a device is turned on and off at the appropriate times. For example, when the host A/V apparatus is turned on, the monitor must be turned on, and when the host A/V apparatus is turned off, the monitor must be turned off. Obviously an out of sync state is not acceptable. In many devices, the “ON/OFF” command is a simple toggle. This allows the possibility that the host A/V apparatus and the device being controlled could get out of sync. One example of how this could occur is if the old remote control that came with the controlled third party hardware Yes or a power button were used to turn the device off. A mechanism for ensuring that an out of sync situation does not occur by detecting current is described in the written description below.

Power strips are commonly available devices that allow a user to plug multiple devices into a single wall outlet. These devices can also function as surge suppressors. This concept can be expanded by adding the ability to detect if the device connected to a particular plug is turned on, as well as the ability to control external third party hardware from the power strip. The power strip is similar to a conventional power strip with the following differences:

1) The plugs are labeled with the device type to be plugged into them. This is for ease of setup and control.

2) The power strip has connectors similar to phone jacks. These are connectors for “IR blasters”. Each IR blaster connector is associated with a plug.

3) There is a serial communications cable between the power strip and the host A/V apparatus. This enables the host to control the IR blasters and to query the power strip to determine if a piece of equipment is turned on.

In addition, each plug contains a circuit that determines if the device that is connected to that plug is turned on or off. This is accomplished by rectifying a measure of the AC current being passed through the connector and comparing this amount of current to a threshold amount for when the third party device in question is turned on. If the threshold is exceeded, it is assumed that the device is turned on. The serial connection from the power strip to the host enables the power strip to communicate the state of the third party hardware in question. If the device is in an undesirable state, such as turned off when it should be on, the host will issue the appropriate command to put the device in the desired state.

This arrangement achieves the goal of being able to control third party hardware effectively. By knowing if the device is on, a sequence of commands can be staged so that the device is turned on prior to issuing those commands.

Note that this embodiment is a power strip. Alternate embodiments include:

A) All functions can be integrated into the host A/V apparatus. This integration can be done permanently or in a modular fashion.

B) The IR blasters can be integrated into the host A/V apparatus. The power strip would inform the host of the state (on or off) of the devices plugged into them.

C) Illumination that indicates whether the plugs are powered “on”.

D) Illumination that indicates that the IR blasters are connected properly.

E) The host device does not have to be an entertainment center. Instead, it can be a command interpreter for the A/V apparatus remote control to control third party devices exclusively. The host device can be programmed with a wiring diagram of the system and issue the appropriate commands to achieve the desired result.

There are two aspects to controlling third party devices: setup and use.

Setup of Third Party Devices

In order for the A/V apparatus to properly control third party devices, the process defined in FIGS. 18 through 22 must be followed. Note that throughout these steps, the user must respond to displayed requests. These requests may be displayed on the monitor or TV set attached to the host A/V apparatus, or they may be displayed on the touchscreen of the remote, or they may be displayed on both. Because these functions are not commonly used, they need not be stored permanently on the remote control, and so may use the bi-directional protocol described on the “No” leg of Step 804

FIG. 18 shows the necessary steps to get third part hardware working properly. The first step to controlling third party hardware with the disclosed A/V apparatus remote control is to ensure that the system works properly using the traditional remote controls, as shown in step 1802. This simplifies troubleshooting because it eliminates the variable of not having the system set up correctly. Note that the third party hardware connects in this embodiment through the host A/V apparatus. The Host A/V apparatus then acts as a junction box, managing multiple inputs and sending them to a single audio output and a single video output. Finally, note that in this embodiment the third party devices are plugged into the current sensing power strip described for the system to work properly.

The next step (1803) is to connect the IR blasters to the described power strip. The IR blaster then should be positioned so that the IR blaster signal will transmit to the IR receiver of the device to be controlled. This can be directly over the IR receiver on the third party device, or at a distance and aimed at the device to be controlled.

At this point, the hardware has been set up correctly to be controlled by the host A/V apparatus. We now enter a process that is repeated for each piece of third party hardware to be added, as indicated in step 1804.

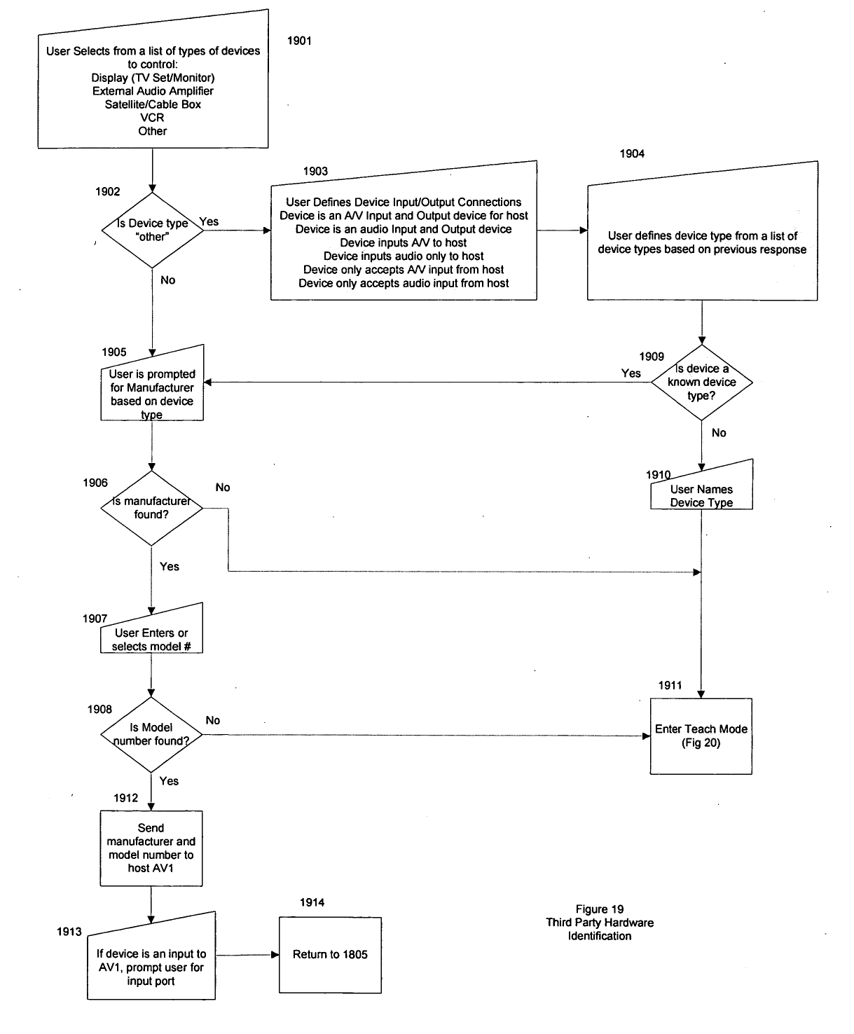

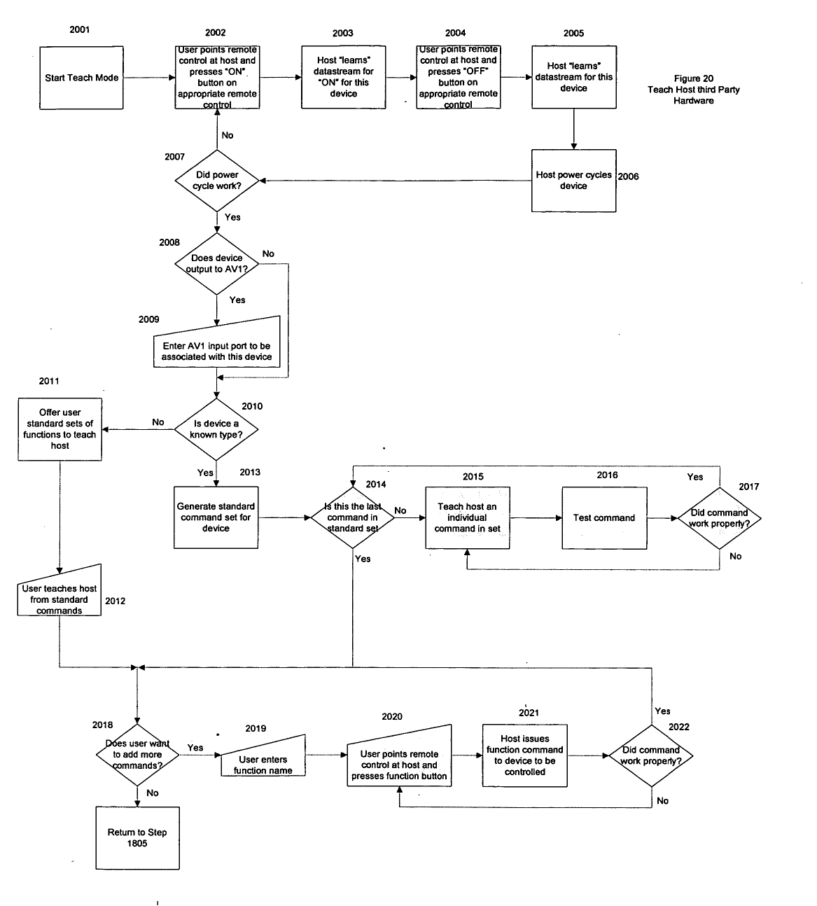

In step 1805, each device is identified by type, manufacturer, and model number. While shown as a single step in 1805, this is actually a process that is described in detail in FIG. 19:

In Step 1901, the user identifies the type of device to control from a list of options. In this example, the list contains five options: a display, such as a TV set or monitor; an external audio amplifier; a satellite or cable box; a video cassette recorder; or other, for devices not included in the list above. Examples of other devices include tape decks and laser disc players.

In Step 1902, we determine if it is a known device type or not. Known device types have known feature (or command) sets and known I/O connections. For example, it is expected that a VCR would have an audio and video input to the host device and may accept the host's audio and video output.

If the device type is known, the user is prompted in step 1905 to enter the manufacturer's name. This can be a selection from an alphabetical list of manufacturers for the appropriate device type, or the user can enter the manufacturer's name using letters that appear on the touchscreen. One option will be “Other” or “Not Found.”

Step 1906 determines if the manufacturer was found. If so, then the user enters or selects the model number for that device type and manufacturer in Step 1907.

Step 1908 determines if the model number is found. If it is, then the model number is returned to the host A/V apparatus in Step 1912. This allows the host to look up the proper codes to control the device, and to organize the remote appropriately.

Step 1913 asks the user to specify the input to the host A/V apparatus if it is an input device. Some devices, such as audio amplifiers and monitors, are only attached to outputs of the host A/V apparatus. After successfully identifying the type, make, model number, and connections of a third party device, the algorithm returns to 1905, as shown in 1914.

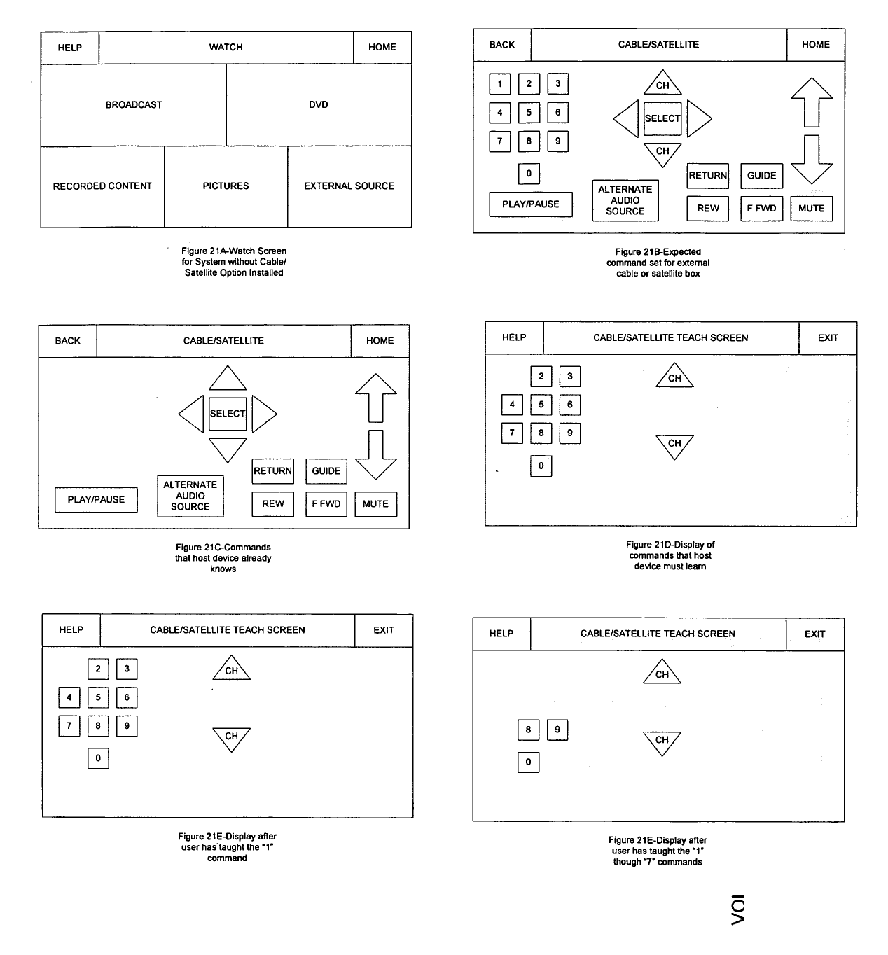

The above description is for the case when the device type, manufacturer name, and model number are all known. In cases when one of these is not known, such as a “No” response in step 1906 or 1908, the host will have to be taught the proper commands. This process is detailed in FIG. 20 and will be detailed after FIG. 19 is fully described.

Returning to FIG. 19, the branch for the “other” device type in step 1902 will now be explored. In this branch, the device type does not fit into the categories in step 1901. The device will need to be described in terms that are useful to ensuring that it works properly in the system. This means that the connections to the host must be defined, as well as the command sets that the device can support. The latter is detailed in the teaching process, FIG. 20; the former is determined at this point in the process.

In step 1903, the user defines the device connections to the host A/V apparatus. This information is used in step 1904 to present a list of possible devices that match that set of connections to the user in order to better define the device. For example, if the device “inputs A/V to host” if could be a Video Cassette Player, a laser disk player, a DVD player, or other video playback device. If the device “is “an A/V input/output device for host” then it could be a DVD burner or external digital video recorder. Based on the device I/O that the user chose in step 1903, a list of options such as those given in the examples above is presented to the user in Step 1904. If the device is a known type (step 1909), then the user is sent to step 1905 and proceeds along that branch. If the device type is unknown, then the user is asked to name the device type (1910) and enters the “Teach Mode”, FIG. 20.

At the time that the user enters FIG. 20:

1) The device type is known. It is either a standard device type as determined in steps 1901 or 19104, or a user named device type, as defined in step 1910.

2) The expected I/O connections to the host device are known. They are pre-defined in the case of known devices and user defined in Step 1903 for user named devices.

3) The functions supported by predefined device types are known. For user defined device types, those functions are unknown.

4) The physical wire connections between the third party device and the host are unknown.

5) The IR bitstreams issued by the traditional remote in response to a command from a user are unknown.

In order for the teach mode to work, the learning device must have an IR receiver built in, as well as the ability to decode the IR signal. These features may be on the power strip or the host device. The teaching method is straightforward. The command to be learned is defined to the host; the command is issued by pressing the appropriate button on the remote control while aiming it at the IR receiver on the learning device; and the signal is decoded and stored by the host and/or learning device. Finally, the command is echoed by the host and the user verifies that the device responds appropriately.

Examining how a remote learns new hardware (FIG. 20), it can be seen that the first step is to learn the On/Off command sequence. This command is universal and so it is logical that it is the first command learned. Steps 2002 through 2007 cover learning this sequence in a straightforward manner.

In step 2008, the host determines if the device outputs to the host. If it does, then it prompts the user to specify the input port on the host for the device (2009). The next step in either case is 2010, where the system determines if the device is a known type. If the device is a known type, then the standard command set for that known type is known and can be generated in step 2013.

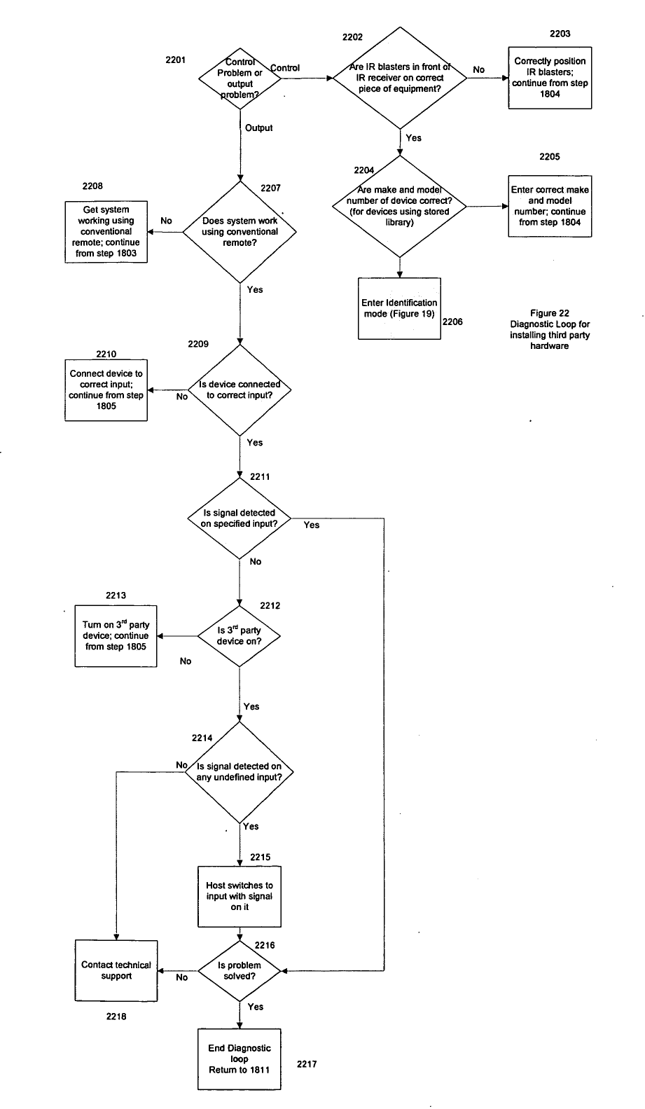

In steps 2014 through 2017, each command in the standard command set is learned by the host device. Note that this can be accomplished efficiently using the touch screen remote. The command set to be learned is presented to the user on the remote control, either in part or in its totality, depending on the number of commands to be learned. The user selects a command on the touchscreen remote to be learned. He then presses the associated button on the traditional remote. Once the command is confirmed as having been learned, it can be removed from the touchscreen, leaving only those commands still to be learned visible. An example of this process is detailed in FIG. 21.

Assume that the user has the host device described in 15B This is duplicated as FIG. 21A. This host device has no built in cable or satellite support. The user wishes to control an external cable box from the host remote's control and so wished to add it as third party hardware. The box's model number is not contained in the host's library; consequently the user must teach the host the commands to be issued. Since the third party hardware's device type is known, the expected commands to be issued can be mapped from the host's equivalent model or other internal database. For a cable or satellite box, these features are shown in 1303, replicated as FIG. 21B.

FIG. 21C shows the commands for the functions that are performed by the host. These include the audio controls, as well as the DVR features, including the guide and its navigation. The features not included in this set need to be taught to the host, so the remote displays the set of features to be taught (FIG. 21D). The user will be guided by commands on the remote and/or monitor as to the necessary steps to take.

The user would be asked to select a command for the host to learn from those available on the remote. In this case, he presses the numeral “1”. He is then instructed to press the numeral “1” on the third party device's remote. The host will then issue the command, and the user will be asked to confirm that the third party device behaved correctly, indicating that the command was learned properly. If the command were learned properly, that command is dropped from the display, as shown in FIG. 21E. FIG. 21F shows that state of the display after the numerals “1” through “7” have been learned.

The user may also opt to not teach a command because he does not use it on the traditional remote control.

It may also be desirable to test commands in groups or in a logical order. For example, Play, Pause, Stop, Fast Forward, and Rewind may be learned and tested as a group rather than individual commands.

Once the standard commands for a known device type have been taught, the user has the ability in step 2018 to teach additional commands. The standard command set may not support all of the features of the device under control, for example. If the user does want to add more commands, the user defines the function (2019), and then teaches the function in steps 32020 through 2022. The user repeats this for as many functions as he desires to add. Once this is accomplished, the user returns to the main flowchart of FIG. 18 at Step 1805.

Returning to 2011, the case where the device type is not known is detailed. The user is offered standard sets of functions to teach, such as playback functions or keypad functions. The user can teach these standard commands to the host in the same manner as 2014 through 2017. Once the user has taught the standard command sets desired, the user can add more commands in Step 2018, where the flowchart returns top the main loop.

At this point in the process, the user has taught the host how to control third party hardware. The next step is to integrate this control of third party hardware with the host remote control. This includes not just adding the commands that were taught, but ensuring that the device logically integrates into the remote control paradigm of “Watch”, Listen,” “Record,” “Move Data,” “Goodies” and “Setup”.

The first step to accomplish this integration is 1806, updating the remote “power” display screen to add this device. This allows the user to manually control the power on this device, although the host will automatically turn on a device if its function is desired, and can automatically turn off a device if the host is turned off. During this step, the user can determine if he wants the device to be powered off when the host is turned off. He can also specify the host's response if this device is powered off or the signal stops while the device is the primary source for the host. For example, if the VCR tape one was watching ended, the host could automatically change the source to the last watched cable channel.

The next step (1807) is for the user to test the power switch on the host remote to ensure that power is correctly controlled. The user may choose to skip this step if it was performed during a teaching phase, but it is should be done for devices whose command sets come from a stored library.

If the device fails the power test, it enters diagnostic mode, to be explained subsequently.

If the device passes the Power Test (1808), the remote display is updated to support added components, based on their I/O configuration (1809). One example can be: Output devices such as audio amplifiers and displays can be placed under “Setup”; Audio only input devices can be placed under “Listen”; and Audio/Video input devices can be added to the “Watch” set of icons. Known device types can have an icon associated with them; named device types can have their name displayed. At the end of the example described in FIG. 21, the remote screen will add the external cable/satellite box to the “Watch” menu, resulting in a screen identical or nearly so to that in FIG. 15A. The two systems-one with an internal cable card, the other with an external cable box-will be functionally equivalent, and the remote display and operation will reflect that equivalence.

In step 1810, the user tests the remote control of the third party device to his satisfaction. The user will be queried after each command to determine if the third party device responded appropriately. If it did not, the user enters diagnostic mode (FIG. 22). Once the user is fully satisfied that the device is working properly (1812), the user can return to step 1804 to add more third party devices, or, if this were the last device to be added, leave the setup portion of the remote control.

In the case that the third party hardware that is being set up fails, the user can enter a diagnostic mode, as shown in FIG. 22.

The goal of the diagnostic flowchart is to determine where the user diverted from the flowchart presented in FIGS. 18, 19, and 21. Once this determination is made, the user will be directed to the correct steps to solve his problem.

The first step (2201) in the diagnostic mode is to determine if the problem is a control problem or an Output problem. A control problem is when the third party device does not respond as expected. One example is a VCR not playing when the “Play” button on the touchscreen remote control is pressed.

An output problem occurs when the audio or video output is not what is expected. For example, the video from an external cable box is displayed correctly, but the audio source is from the FM radio.

The Control Problem Sequence:

In step 2202, the user confirms that the IR blasters are positioned correctly. Note that the host will be able to determine if the IR blaster is not plugged in and can inform the user of this problem.

If the IR blasters are not connected and positioned correctly (2203), the user returns to Step 1804 of FIG. 18.

If the IR blasters are correctly positioned, the user checks the make and model of the third party device (2204). If the make and model are incorrect, then the user enters the correct make and model (2205) and continues from step 1805. If the make and model are incorrect, then the user enters the identification mode, FIG. 19.

For an Output Problem Sequence:

In step 2207, he confirms that the system works with conventional remote controls. If it does not (2208), the appropriate step is to get the system working properly using a conventional remote.

At this point, the logical source of the problem is that the desired input is not being sent to the audio and video output. Thus, the next logical step (2209) is to confirm that the third party device is connected to the correct input(s) on the host. If the third party device is not connected to the correct input(s), the user is directed (2210) to connect to the correct inputs and continue at step 1805. If the user informs the device that it is indeed hooked up correctly, the device will attempt to detect a signal on the specified input port (2211) to confirm this. If no signal is detected the user is asked to confirm that the third party device is indeed on (2212). If the device is off, the user is asked to turn it on (2213) and continue from Step 1805 of FIG. 18. If the third party device is on but no signal detected, the host will determine if there is an input on other ports that do not already have a device associated with them (2214). If no signals are found, this means that there are no valid input signals to the host. In this case, technical support should be contacted (2218). However, if signals are found on inputs, this may be a wiring mistake. The host will switch the input to the port with a signal (2215). If this solves the problem (2216) the diagnostic loop ends successfully (2217). If the problem is not solved, then contacting technical support (2218) is the final step.

There is one final aspect to controlling third party hardware to be discussed. In this case, the third party hardware is designed to a specification supplied by the host. An example of this is controlling a third party amplifier through a USB port.

Digitally Controlled Amplifier

SimpliFi Digital Inc. has designed an audio amplifier that can be digitally controlled using USB, 1394, or other digital protocols. This permits the amplifier to become a slave component within a home entertainment system, as opposed to an independent piece of equipment. This eliminates the need for the integration and teaching steps described above.

The parameters that can be controlled are identical to the parameters that can be controlled with a remote control. These include but are not limited to the following:
Volume
Surround modes
Audio Delay
Equalization across the audible spectrum
Position of listener in the room
Level settings (front/rear balance)

Further, these changes can be made dynamically, based on the music being played or the listener. The surround mode would automatically change to “jazz” for a song identified as belonging to the jazz genre, for example.

The remote also can have a microphone built into it. This microphone would allow the amplifier to tune the outputs to the location where the remote is. This allows the system to be dynamically changed based on a listener's location. Another option would be to tune it for multiple locations, ensuring that the sound output is optimally balanced for all common listening locations in a room.

Note that this other pieces of third party hardware can be designed to act as slave devices to the host, and thus simplify the setup of the device for the user.

A/V Apparatus Access Control Paradigm for Remote Control

There is a need for providing access control to the described A/V apparatus, which can be an integrated, modular home entertainment center with a Bi-Directional remote control such as that described. The technology used for the remote can be Bluetooth, Zigby, or other wireless communication and has three distinct advantages over conventional IR technology.

First, the application can be installed on devices such as Personal Digital Assistants (PDA's) or cell phones. These devices can use the same technology as the A/V apparatus (e.g., Bluetooth, Zigby). They also could use a different protocol to a network or other connection to control the A/V apparatus. In this case, the communication is not made directly between the remote and the host, but through an intermediary. For example, some users have their home entertainment equipment in an A/V closet. Because of distance and/or intervening walls, the remote may not be able to communicate directly with the host. In this case, the user sets up a command receiver in the living room that can communicate wirelessly with the remote. This command receiver then echoes the commands from the remote to the host through a secondary connection, such as an RS232 (Serial Cable) connection. Data, such as channel information, can also be sent from the host to the remote also.

Second, these protocols are not limited to line of sight and the devices can work over a fairly long distance-often 100 feet or more for Bluetooth. Zigby is a lower power protocol and has a greatly reduced range. The remote does not have to be “aimed” at the receiving device in order to work properly.

Third, the remotes can be uniquely identified, so the host can be programmed to respond to only a particular remote's commands. Each Bluetooth module has a unique 128 bit key that it sends as an identifier. Thus, a host unit can reject commands from a remote whose key it does not recognize. Each host unit will only recognize the remote that ships with it from the factory, for example. This will prevent problems in settings with a high density of equipment that could be controlled, such as apartment buildings, dormitories, hospital recovery rooms, sports bars, etc.

One consequence of the unique identification method is that user profiles can be tied to a particular remote controlling device. For example, a teenager's PDA that is used as a remote controlling device would allow access to her music and her recorded shows but not “R” rated movies.

The fact that this access paradigm can be very open results in several cases that must be thoroughly examined to ensure that undesirable consequences do not occur:

1. Hosts may be able to detect multiple remote controls, some of which may be appropriate to control the host, others of which may not be. Ensuring that the desired user is the one remotely controlling the host is of paramount concern. As an example, imagine an apartment building, with adjacent apartments each having A/V apparatus. If access were completely open, the user in Apartment 1A could be changing channels on Apartment 1B's television. Obviously this situation must be prevented. On the other hand, a remote control may be associated with a user rather than a location. For example, the access control algorithm could be downloaded into each family member's PDA, and the living room host could be programmed to accept commands from any of their PDA's. The host must have an access control algorithm to determine which set of remote control commands to respond to in the event that it recognizes multiple remotes.

2. Remotes may be able to detect multiple hosts that they can communicate with. An example may be at a sports bar, where there are several hosts. The bartender would ideally like one remote control to control all of the hosts.

3. Access to content based on age appropriateness of material must be considered. Commonly called parental controls, the A/V apparatus architecture of this patent and the remote control method described offer new solutions to the problem of ensuring that children are not exposed to inappropriate content.

Access may be based on several methods such as:
a. User ID and password
b. Password only
c. Device based, by assuming that a certain device belongs to a particular user.
d. Biometrics-capacitive/resistive measurements, fingerprints, etc.

The above methods may be implemented alone or in combination. One other factor to consider is that the control paradigm must not become so cumbersome as to prevent its usability.

Host-Remote Control Access Control Communication Protocol

The goal of this host-remote control protocol is to have a communication method that is open enough that third party remote controls can communicate with a host A/V apparatus without giving control to the wrong user. For example, in a hospital recovery room, each patient has a television set. Obviously it is not acceptable for a patient to be controlling another patients' television sets. Again, this problem is compounded because the communication has a long range compared to existing IR technology and can pass through a wall.

To address these issues, each A/V apparatus may ship from the manufacturer with a remote control that is linked to that A/V apparatus at the factory (known as the “master remote control”). Initially, each A/V apparatus will only accept commands from its master remote control. The A/V apparatus can be set to recognize other remote controls by any of the following mechanisms:
1. From the master remote control: One option within the remote control setup screen will be to add an additional remote control device. This is accessible when system administrator access is granted by both login ID and password. The A/V apparatus would then recognize the new device through an initialization protocol shown on the A/V apparatus monitor. The monitor would indicate that the host is searching for all remote controls that are in the appropriate setup screen. There should be only one such device, but this may not be the case. The display monitor asks the user to press certain keys on the remote. This allows the host to confirm the particular remote control to be added from the potentially many with which it can communicate. This sequence accomplishes two goals:

First, it ensures that only the desired remote control is added to the list of remote controls that can control the host. Since the command sequence is shown on the host A/V equipment's monitor, only people who can see the monitor will know which keys to press in order to “sync up” the remote with the host. Users who cannot see the monitor will not even know that the host is open to learn a new remote.

Second, other users with similar devices within range of the host will not be disturbed. If the host broadcast that it was “open” and displayed a screen on all remotes with which it could recognize, it would interfere with other remotes within its range. This prevents other remote users from seeing the command sequence to sync up their device with the A/V apparatus. A confirmatory handshake between the A/V apparatus and the new remote control would complete this process.

2. From the host A/V apparatus: One could also use buttons on the A/V apparatus to access the administrator function. This function is useful in case the master remote control is lost or broken. Owners must have a way to regain control of their A/V apparatus units if their original remote becomes disabled. These buttons will be a simple five key arrangement of left, right, up, down, enter. Pressing the enter button would cause the host to display the equivalent of the remote's home page. The user can then use the other arrows to navigate the screens that appear to access the login screen for administrator functions. This process, while cumbersome, would allow use of the host if the remote control were not functioning.

3. By technical support: In the case of the administrator ID and/or password being forgotten, technical support for the sales company must have a network backdoor and backdoor available from the control buttons on the A/V apparatus. These backdoors can be randomly generated. For example, in the case of technical support walking a user through gaining access, the A/V apparatus could display a randomly generated sequence of alpha numeric characters. Technical support would feed these through an algorithm and read back to the A/V apparatus owner, or controller, the correct response that allows access.

Remote Control Identifies Multiple Hosts

Another situation must be considered—that of when a remote control identifies multiple hosts with which it can communicate. For example, in a sports bar the bartender may have numerous television sets, each with its own controller. The bartender obviously would like only one remote to control all hosts—i.e., one remote control to control six hosts. Upon wakeup, the remote will detect multiple hosts and give the user a list of hosts with which it can communicate, as shown in FIG. 23A. The user selects the device to be controlled, and the appropriate screens for the device are loaded. The user may also have a small “Change host” icon available at all times, as shown in FIG. 23B.

Host Recognizing Multiple Remote Controls

Finally, the case of a host recognizing multiple remote controls must be considered. Some people always have their phone or PDA with them. A PDA has a touchscreen that can display the same information as our touchscreen remote. Rather than use the remote, the PDA can be used to control the device. Remotes have unique identifiers and thus names can be associated with those devices, such as “Dad's Blackberry”. All remotes that can control a host device will be placed in a hierarchy list that is stored on the host. The hierarchy will be used to resolve conflicts. The list could include users and devices. A sample list would be:
Master remote control with administrator login
Master remote control with Parent login
Dad's PDA
Adult Child's Cell phone
Teenage child using master remote control
Generic user of master remote control

Another option would be to base control on the parental control access level—the greater the level of parental controls available, the higher the priority for the device. In essence, the conflict management for this case would map to the parental control hierarchy, explained below.

The above discussion concerns ensuring that only the proper remote is controlling the proper host. There is another access issue to be discussed: that of access to differing levels of age appropriate content, generally described as “parental controls”. This feature is addressed below:

Parental Control:

To help parents evaluate content, both the television and movie industries have established rating systems.

The Movie Industry's is Long Established. Its Familiar Rating System is:

G: General Audiences; all ages admitted
PG: Parental Guidance suggested; some material may not be suitable for children
PG-13: Parents strongly cautioned; some material may be inappropriate for children under 13
R: Restricted; under 17 requires accompanying parent or adult guardian
NC-17 No one 17 and under admitted

There are also movies available that do not carry an MPAA rating. Movies that are pornographic in nature or are not theater released often do not carry a Motion Picture Rating.

The TV's Rating System

The TV's rating system is similar to that for movies, although it adds reasons for objections to aid in evaluating the rating. The TV rating system is:
TV-Y: acceptable to all ages. Elements designed for 2-6 year olds.
TV-Y7: designed for children age seven and above.
TV-Y7-FV: More intense or combative fantasy violence than other TV-Y7 programs.
TV-G: Most parents find this program suitable for all ages.
TV-PG: Parental Guidance suggested. The themes may require parental guidance or it may have one or more of the following:
   V-moderate violence
   S-Some sexual situations
   L-infrequent coarse language
   D-some suggestive dialogue
TV-14: Parents Strongly Cautioned. Contains material many parents find unacceptable for children under 14. The program may have one or more of the following:
   V-intense violence
   S-intense sexual situations
   L-strong coarse language
   D-intensely suggestive dialogue
TV-MA: Mature Audience Only. May be unsuitable for children under 18. The program may contain:
   V-graphic violence
   S-Explicit sexual activity
   L-crude indecent language

The video game industry also rates games for content through the Entertainment Software Rating Board (ESRB, www.esrb.org) These ratings are:

EC (Early Childhood)—have content that may be suitable for ages 3 and older. Contains no material that parents would find inappropriate.

E (Everyone)—have content that may be suitable for ages 6 and older. Titles in this category may contain minimal violence, some comic mischief and/or mild language.

T (Teen)—have content that may be suitable for persons ages 13 and older. May contain violent content, mild or strong language, and/or suggestive themes.

M (Mature)—have content that may be suitable for persons ages 17 and older. Titles in this category may contain mature sexual themes, more intense violence and/or strong language.

AO (Adults Only)—have content suitable only for adults. Titles in this category may include graphic depictions of sex and/or violence. Adult Only products are not intended for persons under the age of 18.

Outline of a Method for Exercising Access Control

The idea of parental controls is well understood. The idea behind parental controls is to not allow content above a certain rating threshold to be displayed on the monitor. Thus, if the movie threshold is PG-13 and the TV threshold is TV-14, movies that are rated R or NC 17 and TV shows rated TV-MA will not be displayed. In the case of television, the acceptability of content could be furthered refined. For example, suggestive dialogue (L) may be acceptable but sexual situations (S) may not be.

Currently the following content is rated in a form that the described A/V apparatus can interpret:

All television sources: broadcast, cable, and satellite.

Most DVDs: there are some exceptions. Educational content is not always rated, nor are movies that are not theatrically released. These run the gamut from IMAX movies to pornography.

While the described A/V apparatus may not act as a game platform initially, it may evolve into one. Thus, the described A/V apparatus can support parental controls for game ratings.

The following sources are not rated in a form that the A/V apparatus can interpret:

Broadcast radio: the assumption is that the content is appropriate for all listeners.

Satellite and Internet radio: The assumption is that the content is appropriate for all listeners. This may change with Howard Stern moving to Sirius.

CDs-a voluntary labeling of CDs with a “Parental Advisory” is currently being done. However, there is no way for the A/V apparatus to recognize this age appropriateness of a track or CD.

Downloaded Music or other audio content—there are currently no mechanisms in place to ensure that objectionable audio content is not downloaded.

If the above sources of content are ever rated, the same methods outlined for currently rated content can be applied to content delivery methods that begin applying rating systems.

Finally, note that content that is recorded locally, on its internal hard drive, will have its content rating embedded in the file so that the parental controls can be applied to recorded content also. For example, a TV-MA recording cannot be watched by a user with PG-13 access.

Access Controls and the A/V Apparatus:

Parental controls is simply a subset of controls that the described A/V apparatus may enforce. In addition to parental controls, the described apparatus may do the following based on the level of access granted:
Block Pay Per View (PPV) or Video on Demand (VOD) services
Block access to setup functions
Block the ability to move, copy, and/or delete files
Block the ability to record content such as a TV show, either generically or based on parental control settings.

Because the disclosed A/V apparatus is a self-contained repository of all content delivery mechanisms and data about that content, it can simulate all of the V-chip functions and add additional levels of control. Examples of these additional levels of control include:

Access and display of the online TV content guide can be modified based on current parental control settings. This guide is downloaded over a network connection or through an integrated cable/satellite connection. When viewing the guide, items may be color coded based on rating. A guide layout is essentially a matrix of channels and timeslots. Thus, each show is contained in a rectangle. The background color of that rectangle can indicate maturity rating-Green for general, blue for PG-13, yellow for R, and red for NC-17 (or their TV equivalents). Items with an unacceptable rating may not have their summaries displayed.

Database searches through a video guide may ignore content that exceeds parental control settings. While the guide information is displayed graphically, it is essentially a database. Users can search by show name, actors, keywords, time, channel, etc. A parental control filter can apply to this search so that inappropriate content is screened and ignored by the search filter. Searching for “Sarah Jessica Parker” would skip “Sex in the City” if the filter were applied at a TV-MA level.

Pay per view and video on demand features may be placed under the parental controls paradigm, with access to these functions based on the same algorithm as parental controls, regardless of rating of content. For example, a teenaged user would not be allowed to order pay per view movies, even if they were rated “G”, like “Finding Nemo”. Alternatively, parents could let this child order “PG-13” rated movies to view, but not “R” rated movies.

As mentioned above, many DVDs are unrated. The rating assumption of unrated DVD content can be established during setup of the parental control. For example, unrated DVDs may be assumed to be NC17 in one household and PG in another. Furthermore, individual DVDs can be identified by title and assigned a permanent rating. In the household where DVDs are assumed to be NC17, the A/V apparatus can be taught that an unrated educational DVD designed for toddlers is equivalent to a “G” rating and thus does not need authorization to view. This can be done based on the title or other header information on the DVD itself. Every DVD has header information, including its title. When an unrated DVD is inserted, the host can ask a user to assign a rating to the DVD. The host can create a file listing the DVD name and rating. If a DVD of the same name is inserted again, the host will use that rating to determine whether or not to display the DVD. Another option would be to store a list of all unrated DVDs that have been watched. The host would prompt on a second viewing of a particular DVD title.

Each of the features listed above is currently implemented in commonly available technology. What is unique about the A/V apparatus is that, by integrating all of the home entertainment features into a single box, parental controls can be applied across all content sources in a consistent manner. For example, consider a family, each with their own password access to the host device. Settings for each family member for various forms of content are listed below:

| | | | | | Pay Per | |
|---|---|---|---|---|---|---|
| | Movie Rating | TV Rating | Audio Rating | Game Rating | View/VOD | Special Feature Access |
| Parents | NC17 | TV-MA | Any Content | ESRB rating | YES | Access to all features |
| | | | | of AO | | |
| Teenage | PG-13 | TV-14 | Content rated | Games with | Limited to | No access to setup; |
| Children | | | acceptable for | ESRB rating | PG-13 | able to move data |
| | | | early teenagers | of “T” | movies | |
| Young | G | TV-G | Broadcast Radio | Games with | No. | No access to setup |
| Children or | | | Only; music for | ESRB rating | | or moving data |
| Generic User | | | General audiences | of “E” | | |
| Adult | NC17 | TV-MA | Any Content | ESRB rating of NC-17 | No. | No access to record, |
| Babysitter | | | | | | setup or moving data |

Password Access

Another advantage of the remote control paradigm is the ability to change the features available to the user based on password. Since the remote control is a touchscreen, its appearance—and, by definition, which features it supports—can be modified based on the password. Features such as setup, video editing, recording, data transfer, etc. can be removed from the touchscreen remote for general access. Access to additional features can be reached through a variety of methods—password only, login id and password, or biometrics. FIG. 24 gives a very simplified example of how this control would work. This example is for a two user system; it can be extended logically to additional users.

In Step 2401, the remote displays a list of users. User 1 has basic access to content and functions and does not require password access. Thus, upon selecting “User 1,” the remote notifies the host of the selection made, and the screen shown in 2403 is displayed. This screen can be stored locally on the remote, or shipped from the host in the manner described previously in FIG. 8. Notice that this user only has access to thereof the logical functions-Watch,” “Listen,” and “Goodies”. In this example, the basic user, User 1, cannot record any content, move data to, from, or within the device, or access any of the features in setup. Furthermore, the user may be further restricted within these screens. For example, the user, based on his personal settings, may be blocked from accessing satellite radio content, even though the user has access to the “Listen” screen.

In place of one of these functions is a button to change users. This allows a manual override of the default settings—for example, if a parent wants to set up a recording session right while his child is listening to a CD.

Turning to User 2, this use has access to more advanced functions and mature content, and thus this access is protected. Upon granting of access, the remote displays the screens shown in FIG. 2405. Again, this screen can be stored on the remote, or be sent from the host.

Note that access can be granted by a number of different methods-password, ID and password, or via biometrics. Biometric control can be as basic as capacitive or resistive measurement between two thumbs, to rudimentary fingerprint recognition, to other methods.

Access settings are established at the time that a user is created. This is reached through the “Setup” option. For example, under “Setup” “Parental Controls” one option may be add new user. The User name is identified, and the user's age is requested. This can be used to establish a generic profile for the user. This generic profile can be adjusted based on a parent's preferences.

Two of the slots are listed as blank in FIG. 2403. In actual use, the active icons may be rearranged and/or enlarged to fill available space on the display. Each “slot” for an icon will contain a known number of pixels. The icon to be placed in that location will contain fewer pixels, since supported features are being removed. Thus, the icon can be centered in each slot, surrounded by white space, without any changes. The icon could also be increased in size by adding white pixels as necessary to make it the correct size. The icons may also be rearranged so that the display is esthetically pleasing, without empty patches in the middle.

Returning to user 2, the access time for a given password entry must be limited by some method, for obvious reasons. Otherwise the remote would never exit from User 2's control. When the access period has ended, the user will be prompted for a password to be entered. If an incorrect or no password is entered, then control reverts to the basic level of control afforded User 1. During the time that this is occurring, the host will pause live TV; if the password is successfully entered, then the host can play the live TV from where it was paused, ensuring that the user does not miss any content.

Methods of turning off access granted by password can be any or all of the following:

A set period of time, usually half hour increments. This time period could be set by the user.

Set to expire at the end of the current show. The user can watch the show to the end. The user would have to enter the password at the end of the show to continue watching at the current level of access. Note that this would be based on the original show when the password was entered; channel surfing would not affect the time at which the password expired.

Manual control, essentially a logout command. For example, assume that the father is using the remote with his password and thus has full access. Prior to leaving, he can “logout” so that the system now assumes that a generic user with limited access is controlling the described A/V device.

One final feature of this method is the ability for each user to have access to their own content—whether it be music, recorded shows, downloaded video, etc. For example, when a CD is played it can be converted to MP3 format and stored on the hard drive. A device may have many users and hundreds of CDs stored. A user may have difficulty creating a playlist or finding a song, artist, or album to listen to. Instead, the converted content could be stored to a user's individual directory to reduce the clutter.

Parental Control Methods and Paradigm

Parental Controls can be established by a number of different methods: globally, so that the same standard is always applied; user controlled based on passwords; time of day; or for a specific time starting and ending time period.

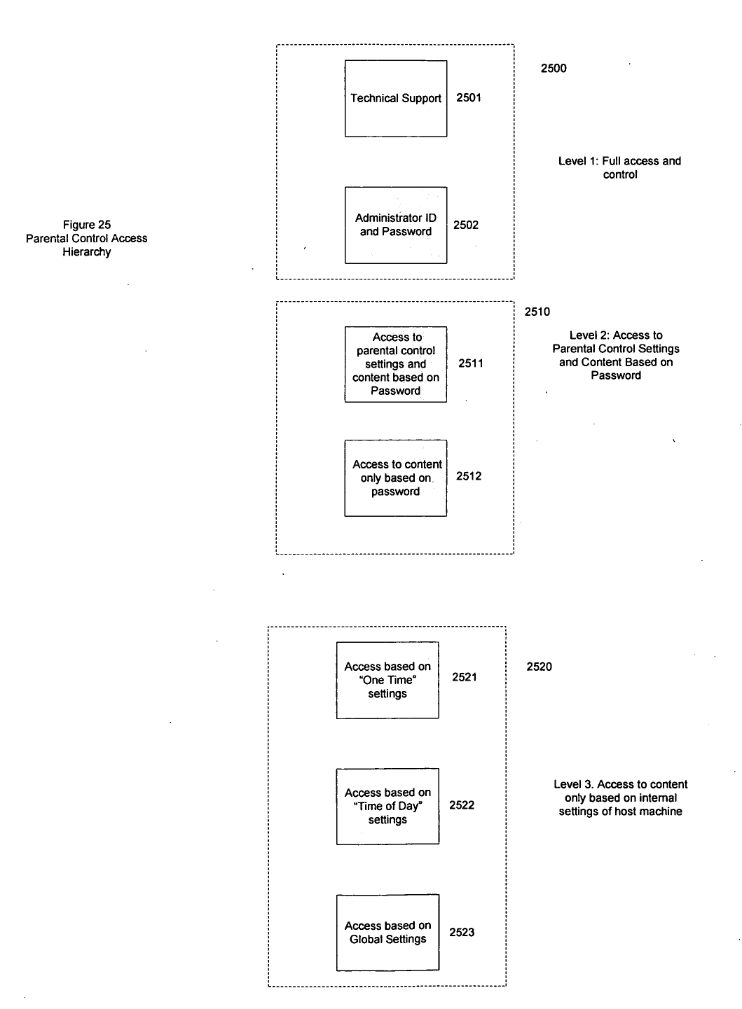

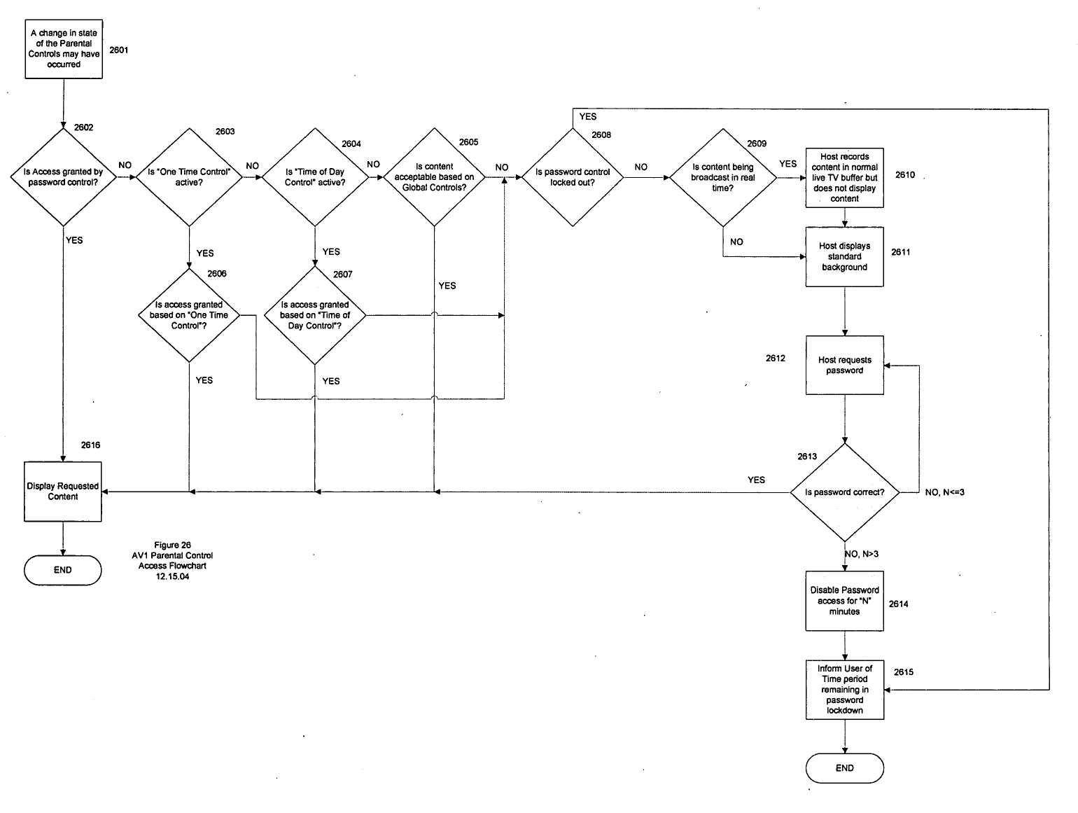

FIG. 25 shows the hierarchy of parental control access, with the top being the highest level of control, overriding controls that are below it. The control breaks down into three levels:

Level 1, the administrator, or full access and control, level, is shown as Item 2500. There are two methods of access within this level:

Technical Support Backdoor (Item 2501)—this is a subset of general technical support access control. For example, if a parent forgets the password to access the parental controls, he or she can call technical support who could reset it.

Administrator ID and Password (Item 2502)—this combination allows the System Administrator access to all settings, not just parental control functions. For example, it allows the host to learn another remote control. The system administrator login and password should only be known to the parents, since it allows access to all controls.

Level 2 is parental control giving conditional access based on password control and is indicated by Item 2510.

Two aspects of parental controls are in effect in item 2510—controlling settings and granting access to content. Granting access to content (Item 2512) is straightforward-access is granted based on the password entered. Each parent may have their own password, with another for their teenaged child and a third for their pre-teen.

As mentioned earlier, the access granted by entering a password must expire at some point. Most users will not turn this access off manually; therefore, an expiration period must be set. This expiration can be based on a specified time period, or the end of a television show or movie. The guide information can be used to determine at which time a particular show has ended.

Note that if this access expires the system will pause live video and prompt for the password to continue access. If the access is granted, the video will begin playing from the point at which it was paused—the user does not lose any content during this period.

Up to two of the passwords will have access to parental control settings (Item 2511). These “power users” can establish any of the lower priority settings, but do not have access to the full system. These include the level of access granted for a given password; setting controls for a given time period; setting controls based on time of day; global levels of control; and the length of time access is granted once a password is entered.

Level 3 (Item 2520) is the lowest level of control and based on settings within the A/V apparatus. There are three levels of control here.

Set Parental Controls for a Limited Time Period (Item 2521)—for example, if the parents are going out for an evening, they may lock the system to a lower level than normal so that their children do not view objectionable content. They also may turn off features such as pay per view or video on demand to ensure that extra charges are not run up. The system can be set to unlock at a specified time or turned off by the parents upon their return.

During this period, the clock will not be able to be reset. In case of power loss, the internal clock will become the primary timekeeper until an Internet connection can be made and the correct time confirmed. An alternate embodiment would be to use the atomic clock broadcast on AM radio to set time. Another option would be to set a countdown timer to counteract attempts to defeat the system.

Set Parental Controls by Time of Day (Item 2522): Some parents may want to have a high level of parental control during the day and “loosen up” the parental controls after their children have gone to bed. This is yet another setting.

Set Global Level of Parental Control (Item 2523)—this is the default level of parental control and lowest on the hierarchy. It can be overridden by any of the other settings.

FIG. 26 shows a flowchart for monitoring the conditional access to content.

Step 2601 shows that there is a change in the state of the parental controls. This change can arise from a number of different circumstances:
1) The rating of the content on the current channel may change when the show changes.
2) The channel may be changed.
3) A timer may turn on or off that grants or blocks access. For example, the time of day controller may clamp down, causing the currently displayed program to no longer be acceptable.
4) A DVD may be played.
5) A recorded show may be played back.

Any such change will cause the parental controls to go into the parental controls test loop, steps 2602 through 2607. In this loop, it checks the rating of the content versus the various levels of control that the device can have. If the content is unacceptable based on the hierarchical control, then the content is not shown. Items 2608 through 2613 enable a password control override that gives the user the opportunity to view content that the current settings do not allow. Note that the user has three tries to enter the password before being locked out of content at that level.

Note that these explanations are for television. They apply just as well to audio (CDs, MP3's, satellite radio, internet radio), games, DVDs, or other rated content.

Note also that the access to content can be controlled by both password and remote identification for the multiple remote scenario. For example, the remote control function could be contained on a cell phone, PDA or other device that a user carries, rather than on a device that remains in the living room. In this case, the parents may “unlock” the host device to watch a TV-MA recording. In traditional systems, the system may stay open for a period of time after the viewing, and the restricted viewer could have access to unacceptable content. In this scenario, the restricted viewer's device-PDA or cell phone in this example—would not allow access to the content because it was not the device that allowed the access.

Re-rating of content-users with high levels of access may re-rate content. Parents may feel that a show given a TV-14 rating really should be TV-MA. The parents then could ensure that all occurrences of that show are rated thus.

Power Management

The A/V apparatus remote requires power management in order to achieve an acceptable time period between charges. The remote will first power down the display after a period of time, then turn itself off after a longer period of time. When the remote is powered back on, the remote cannot display the home page, because it will be out of sync with the host.

For example, imagine that you are watching a DVD movie. After hitting Play, the remote is not needed for a period of time and so powers down. If the user desires to pause the movie—to go to the bathroom, for example, or because the phone rings—the user should be taken to the DVD screen page immediately. He cannot be forced to go through the steps-“WATCH” “DVD” to get to the DVD commands.

There are two solutions to this problem. The first is for the remote to remember the page that it was last on when it was powered down. A second option is for the remote to query the host for its status. In effect, the host would tell the remote which page to display.

The latter method is more effective in instances where a particular remote may be used for more than one device or a host may accept commands from more than one remote. For example, a remote from the bedroom may be used to control the living room host. By querying the host as to its state, the remote is sure to be in sync with the host when it wakes up.

1. A remote control device for controlling a remotely controllable apparatus, said device comprising a touchscreen display.

2. The remote control device of claim 1 further including storage and a receiver and capable of receiving and storing control information from the remotely controllable apparatus.

3. The remote control device of claim 2 wherein said information is information for controlling original controllable components of said apparatus that are installed in said apparatus

4. The remote control device of claim 3 wherein said information is information for controlling controllable components of said apparatus that are installed after said original controllable components are installed.

5. A remote control device including a touchscreen, storage, a transmitter and a receiver, wherein touching predetermined parts of said touchscreen results in information received by said receiver and stored in said storage being transmitted by said transmitter from said storage to said controllable apparatus for controlling said apparatus.

6. A remote control device capable of receiving control information from controllable host, said control information usable by said remote control device for controlling said controllable said host.

7. The remote control device of claim 6 comprising a touchscreen display.

8. The remote control device of claim 7 including a receiver for receiving said information from said host, storage for storing said information, and a transmitter, wherein touching predetermined parts of said touchscreen results in said information being transmitted by said transmitter from said storage to said controllable host for controlling said host.

9. The remote control of claim 8 wherein said information is information for controlling original controllable components of said host that are installed in said host.

10. The remote control device of claim 9 wherein said information is information for controlling controllable components of said apparatus that are installed in said host after said original controllable components are installed in said host.

11. A remote control device comprising a touchscreen, a receiver, storage and a transmitter, said remote control device capable of receiving by said receiver control information from a controllable host, said control information stored in said storage and capable of being displayed on said touchscreen.

12. The remote control device of claim 11 wherein, in response to a user touching predetermined parts of said touchscreen, said stored information is transmitted by said transmitter to said controllable host for controlling said controllable host.

13. The remote control device of claim eleven in which said control information is arranged principally in terms of logical function.
